(19) United States
(12) Patent Application Publication
(10) Pub. No.: US 2026/0214533 A1
(43) Pub. Date: Jul. 23, 2026

(54) CONFIGURATION OF CHANNEL STATE INFORMATION REFERENCE SIGNAL FOR TRACKING AND MEASUREMENTS IN WIRELESS COMMUNICATIONS

(71) Applicant: ZTE Corporation, Shenzhen (CN)

(72) Inventors: Ling YANG, Shenzhen (CN); Bo GAO, Shenzhen (CN); Xiaolong GUO, Shenzhen (CN); Ke YAO, Shenzhen (CN)

(21) Appl. No.: 19/569,547

(22) Filed: Mar. 17, 2026

Related U.S. Application Data
(63) Continuation of application No. PCT/CN2023/122833, filed on Sep. 28, 2023.

(51) Int. Cl. H04W 36/00; H04B 7/06; H04W 72/232; H04W 74/0833

(52) U.S. Cl. CPC H04W 36/0085; H04B 7/0626; H04W 72/232; H04W 74/0833

(57) ABSTRACT

A method of wireless communication is provided. The method comprises: determining, by a user device, whether and/or when to perform a measurement and/or a tracking operation according to a predetermined rule; performing, in case that the determining determines to perform the measurement and/or the tracking operation, the measurement and/or tracking operation before a cell switch command, during the cell switch command, or after the cell switch command; and skipping, in case that the determining determines not to perform the measurement and/or the tracking operation, the measurement and/or tracking operation before a cell switch command, during the cell switch command, or after the cell switch command.

### CROSS-REFERENCE TO RELATED APPLICATIONS

This application is a continuation and claims priority to International Application No. PCT/CN2023/122833, filed on Sep. 28, 2023, the disclosure of which is hereby incorporated by reference herein in its entirety.

### TECHNICAL FIELD

This document relates to systems, devices and techniques for wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various methods and apparatus for configuring channel state information reference signals for tracking in wireless communications are provided.

In one example aspect, a method of wireless communication is disclosed. The method comprises: determining, by a user device, whether and/or when to perform a measurement and/or a tracking operation according to a predetermined rule; performing, in case that the determining determines to perform the measurement and/or the tracking operation, the measurement and/or tracking operation before a cell switch command, during the cell switch command, or after the cell switch command; and skipping, in case that the determining determines not to perform the measurement and/or the tracking operation, the measurement and/or tracking operation before a cell switch command, during the cell switch command, or after the cell switch command.

In yet another example aspect, a wireless communications apparatus comprising a processor is disclosed. The processor is configured to implement methods described herein.

In another example aspect, the various techniques described herein may be embodied as processor-executable code and stored on a computer-readable program medium.

The details of one or more implementations are set forth in the accompanying drawings, and the description below. Other features will be apparent from the description and drawings, and from the claims.

### BRIEF DESCRIPTION OF THE DRAWINGS

FIG. 1 illustrates an example of TRS (tracking reference signal) with QCL (quasi co location) type A and QCL type D that are indicated by a TCI (transmission configuration indication) state for DMRS (demodulation reference signal) of PDCCH (physical downlink control channel)/PDSCH (physical downlink shared channel).

FIG. 2 shows an example of TRS with QCL type A and CSI-RS for beam management with QCL type D that are indicated by a TCI state for DMRS of PDCCH or PDSCH.

FIG. 3 illustrates a SSB (synchronization signal block) with QCL type C and QCL type D that are indicated by a TCI state for DMRS of PDCCH/PDSCH.

FIG. 4 illustrates a SSB with QCL type A and QCL type D that are indicated by a TCI state for DMRS of PDCCH/PDSCH.

FIG. 5 illustrates a QCL relationship for a QCL type A/C and D with SSB associated with TRS for DMRS of PDCCH/PDSCH.

FIG. 6 illustrates a QCL relationship for QCL type A/C and D with TRS associated with SSB for DMRS of PDCCH/PDSCH.

FIG. 7 shows an example wireless communications network based on some implementations of the disclosed technology.

FIG. 8 is a block diagram of an example of a wireless communication apparatus based on some implementations of the disclosed technology.

FIG. 9 is an example flowchart of a wireless communication method based on some implementations of the disclosed technology.

### DETAILED DESCRIPTION

The disclosed technology provides implementations and examples for configuring channel state information reference signals for tracking in wireless communications.

When the UE moves from the coverage area of one cell to another cell, at some point a serving cell change needs to be performed. Currently serving cell change is triggered by L3 measurements and is done by RRC signalling triggered Reconfiguration with Synchronisation for change of PCell and PSCell, as well as release add for SCells when applicable. All cases involve completing L2 (and L1) resets, which leads to longer latency, larger overhead and longer interruption time than beam switch mobility. The goal of L1/L2 mobility enhancements is to enable a serving cell change via L1/L2 signalling, in order to reduce the latency, overhead and interruption time.

Implementations of the disclosed technology provide techniques for configuring CSI-RS for tracking and/or measurement.

In the recent standard meeting (RAN Plenary #94 e-meeting), a new work item (WI) on Further NR mobility enhancements was approved. The goal of this WID is to enable a serving cell change via L1/L2 signaling with low latency, overhead and interruption time. In order to support cell change, some enhancement on CSI-RS for tracking and/or measurement needs to supported, e.g., whether to support at least one of CSI-RS based measurement, CSI-RS as QCL source in activated or indicated TCI state before cell switch command, CSI-RS configuration for different uses case (e.g., beam management, TRS tracking, CSI acquisition, interference measurement), how to determine or establish relationship between CSI-RS index indicated in a TCI state and CSI-RS resource index or CSI-RS resource set index, how to reduce signaling overhead of CSI-RS configuration and so on.

In this patent document, CSI-RS, Channel State Information-Reference Signal can be used for at least one of beam management, tracking, CSI acquisition, mobility, CSI-IM, Channel State Information-Interference Measurement), or others.

In this patent document, TCI State indicates the large-scale attributes that can be obtained from certain reference signals, that is, TCI state indicates up to 2 QCL source RS and QCL Type information. Source RS can be at least one of SSB, or CSI-RS. QCL type can be at least one of type A, type B, type C, or Type D, when type A corresponds to {Doppler shift, Doppler spread, average delay, delay spread}, type B corresponds to {Doppler shift, Doppler spread}, type C corresponds to {Doppler shift, average delay}, and type D corresponds to {Spatial Rx parameter}.

A device can perform time and/or frequency tracking on DL RS not only to ensure reliable communication with network or base station but also to enable high bit rates. Coarse time and/or frequency tracking can be achieved by SSB. Fine time and/or frequency tracking can be achieved by CSI-RS or SSB.

The time and/or frequency tracking process includes estimating the time and/or frequency offsets of the received DL signals and adjusting the local time and/or frequency of the UE receiver in accordance to the estimated time/frequency offsets.

Through time tracking operations, the UE aligns its receiver's local timing to that of the DL signals received from the serving cell. An important metric in time tracking is time resolution which is defined as the minimum time granularity the UE can estimate and adjust between the received DL signal and its local timing. The achievable time resolution depends on the implemented algorithm for time tracking and more importantly on the structure of the timing measurement signal. The bandwidth of the timing measurement signal is critical to the achievable time resolution because the time resolution is inversely proportional to the signal bandwidth. Another important aspect is the time/frequency RE density of the timing measurement signal. The timing offset estimation gets more accurate with increasing the number of resource elements in the timing measurement signal.

For frequency tracking, the time density of the synchronization measurement signal impacts frequency tracking performance.

In order to perform time and/or frequency tracking, CSI-RS for tracking needs to be configured to achieve such functionality. The configuration of CSI-RS for tracking may include parameters, such as on/off, number of antenna ports, RE pattern, periodicity, timing offset, RS index or TCI state index, density, etc. Some details of the configuration on CSI-RS for tracking can be found in the following part.

Note that CSI-RS for tracking can be replaced with TRS.

Regarding CSI-RS for tracking in legacy, the following characteristics are implemented.
UE is configured with a UE specific configuration of a NZP-CSI-RS-ResourceSet configured with parameter trs-Info.
For a NZP-CSI-RS-ResourceSet configured with the higher layer parameter trs-Info, the antenna port with the same port index of the configured NZP CSI-RS resources in the NZP-CSI-RS-ResourceSet is the same.
   For frequency range 1, UE may be configured with one or more NZP CSI-RS set(s), where a NZP-CSI-RS-ResourceSet consists of four periodic NZP CSI-RS resources in two consecutive slots with two periodic NZP CSI-RS resources in each slot. If no two consecutive slots are indicated as downlink slots by tdd-UL-DL-ConfigurationCommon or tdd-UL-DL-ConfigDedicated, then the UE may be configured with one or more NZP CSI-RS set(s), where a NZP-CS-RS-ResourceSet consists of two periodic NZP CS-RS resources in one slot.
   For frequency range 2, UE may be configured with one or more NZP CSI-RS set(s), where a NZP-CS-RS-ResourceSet consists of two periodic CS-RS resources in one slot or with a NZP-CSI-RS-ResourceSet of four periodic NZP CS-RS resources in two consecutive slots with two periodic NZP CSI-RS resources in each slot.
Each CSI-RS resource set is configured by higher layer parameter NZP-CSI-RS-ResourceSet
   Wherein, IE NZP-CSI-RS-ResourceSet is a set of Non-Zero-Power (NZP) CSI-RS resources (their IDs) and set-specific parameters.

| NZP-CSI-RS-ResourceSet ::= | SEQUENCE { |
|---|---|
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet)) OF NZP-CSI-RS-ResourceId,

| | | |
|---|---|---|
| repetition | ENUMERATED { on, off } | OPTIONAL, |

-- Need S

| | | |
|---|---|---|
| aperiodicTriggeringOffset | INTEGER(0..6) | OPTIONAL, |

-- Need S

| | | |
|---|---|---|
| trs-Info | ENUMERATED {true} | OPTIONAL, |

```
-- Need R
  ...,
  [[
```

| | |
|---|---|
| aperiodicTriggeringOffset-r16 | INTEGER(0..31) |

```
OPTIONAL -- Need S
  ]],
  [[
```

| | | |
|---|---|---|
| pdc-Info-r17 | ENUMERATED {true} | OPTIONAL, |

-- Need R

| | |
|---|---|
| cmrGroupingAndPairing-r17 | CMRGroupingAndPairing-r17 |

OPTIONAL, -- Need R

| | |
|---|---|
| aperiodicTriggeringOffset-r17 | INTEGER (0..124) |

OPTIONAL, -- Need S

| | |
|---|---|
| aperiodicTriggeringOffsetL2-r17 | INTEGER(0..31) |

OPTIONAL -- Need R
]]
}

| | |
|---|---|
| CMRGroupingAndPairing-r17 ::= | SEQUENCE { |
| nrofResourcesGroup1-r17 | INTEGER (1..7), |

| | |
|---|---|
| pair1OfNZP-CSI-RS-r17 | NZP-CSI-RS-Pairing-r17 |

OPTIONAL, -- Need R

| | |
|---|---|
| pair2OfNZP-CSI-RS-r17 | NZP-CSI-RS-Pairing-r17 |

OPTIONAL -- Need R
}

| | |
|---|---|
| NZP-CSI-RS-Pairing-r17 ::= | SEQUENCE { |
| nzp-CSI-RS-ResourceId1-r17 | INTEGER (1..7), |
| nzp-CSI-RS-ResourceId2-r17 | INTEGER (1..7) |

}

aperiodicTriggeringOffset is used to provide an offset X between the slot containing the DCI that triggers a set of aperiodic NZP CSI-RS resources and the slot in which the CSI-RS resource set is transmitted.
aperiodicTriggeringOffsetL2 is used to indicate triggering offset of aperiodic NZP CSI-RS resources used for fast activation of the SCell, when the NZP CSI-RS resources are activated by the MAC CE.
nzp-CSI-RS-Resources is NZP-CSI-RS-Resources associated with this NZP-CSI-RS resource set.
trs-Info is set to “ture” is used to indicate that the antenna port for all NZP-CSI-RS resources in the CSI-RS resource set is same.
Each CSI-RS resource is configured by the higher layer parameter NZP-CSI-RS-Resource.
   Wherein, IE NZP-CSI-RS-Resource is used to configure Non-Zero-Power (NZP) CSI-RS transmitted in the cell.

| | |
|---|---|
| NZP-CSI-RS-Resource ::= | SEQUENCE { |
| nzp-CSI-RS-ResourceId | NZP-CSI-RS-ResourceId, |
| resourceMapping | CSI-RS-ResourceMapping, |
| powerControlOffset | INTEGER (−8..15), |
| powerControlOffsetSS | ENUMERATED{db−3, db0, db3, db6} |

OPTIONAL, -- Need R

| scramblingID | ScramblingId, | |
|---|---|---|
| periodicityAndOffset | CSI-ResourcePeriodicityAndOffset | OPTIONAL, |

-- Cond PeriodicOrSemiPersistent

| | | |
|---|---|---|
| qcl-InfoPeriodicCSI-RS | TCI-StateId | OPTIONAL, -- Cond |

```
Periodic
    ...
    }
```

CSI-RS-resourceMapping is used to configure the resource element mapping of a CSI-RS resource in time and frequency domain. Where, including Frequency domain allocation within a physical resource block, the number of ports, Time domain allocation within a physical resource block, CDM type, Density of CSI-RS resource measured in RE/port/PRB, starting of CSI-RS in frequency domain, Number of PRBs across which CSI-RS resource spans in frequency domain.
   For CSI-RS for tracking, the number of ports is 1.
   For CSI-RS for tracking, Density of CSI-RS resource measured in RE/port/PRB is 3.
   For CSI-RS for tracking, the bandwidth of the CSI-RS resource is min (52,

$${N}_{BWP , i}^{size} ) ,$$

or

$${N}_{BWP , i}^{size}$$

PRB, or X resource blocks. Wherein,

$${N}_{BWP , i}^{size}$$

is the number of RB of BWP i. wherein, X≥28 resource blocks if the UE indicates trs-AddBW-Set1 for the trs-AdditionalBandwidth capability for CSI-RS for tracking or addBW-Set1 for the aperiodicCSI-RS-AdditionalBandwidth capability for aperiodic CSI-RS for fast SCell activation and X≥32 if the UE indicates trs-AddBW-Set2 for the AdditionalBandwidth capability for CSI-RS for tracking or addBW-Set2 for the aperiodicCSI-RS-AdditionalBandwidth capability for aperiodic CSI-RS for fast SCell activation.
the periodicity and slot offset for periodic NZP CSI-RS resources is one of 2^{μ}Xₚ slots where xₚ=10, 20, 40, or 80.

| | |
|---|---|
| CSI-RS-ResourceMapping ::= | SEQUENCE { |
| frequencyDomainAllocation | CHOICE { |
| row1 | BIT STRING (SIZE (4)), |
| row2 | BIT STRING (SIZE (12)), |
| row4 | BIT STRING (SIZE (3)), |
| other | BIT STRING (SIZE (6)) |

},

| | |
|---|---|
| nrofPorts | ENUMERATED {p1,p2,p4,p8,p12,p16,p24,p32}, |
| firstOFDMSymbolInTimeDomain | INTEGER (0..13), |
| firstOFDMSymbolInTimeDomain2 | INTEGER (2..12) |

OPTIONAL, -- Need R

| | |
|---|---|
| cdm-Type | ENUMERATED {noCDM, fd-CDM2, cdm4-FD2-TD2, cdm8- |

FD2-TD4},

| | |
|---|---|
| density | CHOICE { |
| dot5 | ENUMERATED {evenPRBs, oddPRBs}, |
| one | NULL, |
| three | NULL, |
| spare | NULL |

},

| | |
|---|---|
| freqBand | CSI-FrequencyOccupation, |

...
}

powerControlOffset is power offset of PDSCH RE to NZP CSI-RS RE.
powerControlOffsetSS is power offset of NZP CSI-RS RE to SSS RE. Same value across all resources.
periodicityAndOffset is to provide periodicity and offset. Same value across all resources.
the periodicity and slot offset for periodic NZP CSI-RS resources, as given by the higher layer parameter periodicityAndOffset configured by NZP-CSI-RS-Resource, is one of 2^{μ}Xₚ slots where xₚ=10, 20, 40, or 80
qcl-InfoPeriodicCSI-RS or MC-StateId is used to provide QCL source and QCL type. Wherein, for periodic CSI-RS, the source can be SSB or another periodic-CSI-RS.

### Example Embodiment 1

A signaling can activate or select one or multiple TCI states, such as {TCI state #x_1, TCI state #x_2, TCI state #x_3, . . . , TCI state #x_a, TCI state #y_1, TCI state #y_2, TCI state #y_3, . . . TCI state #y_b}, wherein, the signaling can be at least one of RRC signaling, MAC CE signaling, or DCI signaling. Optionally, one or multiple TCI states are activated or selected from TCI state set or list. Optionally, activated or selected TCI state(s) are associated with or from the same or different cells. The cell can be the candidate cell or serving cell.

Each TCI state contains QCL source RS and QCL type. The QCL source RS can be SSB, CSI-RS, or SRS. The QCL type can be one of‘typeA’, ‘typeB’, ‘typeC’, ‘typeD’, each of which is defined as follows:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

TCI state #X_i includes or indicates SSB or CSI-RS or TRS, and TCI state #Y_t includes or indicates SSB or CSI-RS, TRS. i is 1, 2, 3, . . . , a, t is 1, 2, 3, . . . b. a or b is any of an integer larger than or equal to 0 or 1.

In some implementations, whether CSI-RS or CSI-RS for tracking or TRS is allowed to be configured as QCL source in TCI state, or whether CSI-RS for tracking is configured or allowed before cell switch command depends on UE capability.

Upon receiving one or multiple TCI states activated or selected by the signaling, UE can obtain some information, such as SSB or CSI-RS or TRS or CSI-RS for tracking as QCL source/reference RS and corresponding QCL type. Optionally, SSB or CSI-RS or TRS or CSI-RS for tracking indicated in TCI state is associated with candidate cell or candidate target cell or target cell or serving cell. Or TCI state including SSB or CSI-RS or TRS or CSI-RS for tracking is associated with candidate cell or candidate target cell or target cell or serving cell.

Although CSI-RS or TRS or CSI-RS for tracking is configured as QCL source/reference RS and corresponding QCL type, it does not mean that UE can perform (time and/or frequency) tracking by CSI-RS or TRS or CSI-RS for tracking since TCI state only indicates CSI-RS or TRS or CSI-RS for tracking index. UE may not necessarily know the specific CSI-RS resource information since CSI-RS related configuration is not configured, or CSI-RS related configuration is configured, but is not enabled or is not allowed to be applied, or no specific information is included in CSI-RS related configuration.

If CSI-RS resource and/or CSI-RS resource set related information is not configured, and/or, even if CSI-RS related configuration is configured but not enabled or not allowed to be applied, or no specific information is included in CSI-RS related configuration, then UE cannot perform or complete tracking operation through CSI-RS since UE only knows CSI-RS index indicated in TCI state without knowing specific CSI-RS location information corresponding to the CSI-RS index. The CSI-RS location information includes at least one of CSI-RS resource configuration, CSI-RS resource set configuration, and others.

In some implementations, tracking operation can be achieved or performed by CSI-RS or TRS or CSI-RS for tracking indicated in TCI state, or configured or triggered by signaling or CSI-RS related configuration. In some implementations, the TCI state mentioned here corresponds to the activated or selected TCI state.

In some implementations, before receiving cell switch command (CSC), at least one of the following can be considered for CSI-RS for tracking or TRS:
Scheme-1: TCI state indicating or including QCL type with TRS or CSI-RS for tracking or CSI-RS can be applied for UE to measure and/or track CSI-RS.
Scheme-2: TCI state indicating or including QCL type with TRS or CSI-RS for tracking or CSI-RS can be applied for UE to measure and/or track CSI-RS. Optionally, it can be for the case that if at least one of CSI-RS measurement or TRS or CSI-RS for tracking is allowed and/or configured before cell switch.
Scheme-3: TCI state indicating or including QCL type with TRS or CSI-RS for tracking or CSI-RS cannot be applied for UE to measure and/or track CSI-RS. Optionally, it can be for the case that if CSI-RS measurement is not configured and/or allowed before cell switch command, and/or, if CSI-RS measurement is configured but not allowed before cell switch command, and/or, if TRS or CSI-RS for tracking is not configured and/or allowed before cell switch command, and/or, if TRS or CSI-RS for tracking is configured but not enabled or not allowed or no specific information in CSI-RS related configuration before cell switch command.
Scheme-4: TCI state indicating or including QCL type with TRS or CSI-RS for tracking or CSI-RS can be applied for UE to measure and/or track SSB associated with TRS or CSI-RS for tracking or CSI-RS. Optionally, it can be for the case that if CSI-RS measurement is not configured and/or allowed before cell switch command, and/or, if CSI-RS measurement is configured but not allowed before cell switch command, and/or, if TRS or CSI-RS for tracking is not configured and/or allowed before cell switch command, and/or, if TRS or CSI-RS for tracking is configured but not enabled or not allowed or no specific information in CSI-RS related configuration before cell switch command.

Note that the TCI state can be activated or selected TCI state before cell switch command. In this case, at least one of the following can be considered:

In some implementations, CSI-RS or TRS or CSI-RS for tracking indicated in TCI state is associated with candidate cell or candidate target cell or target cell or serving cell. Or TCI state including CSI-RS or TRS or CSI-RS for tracking is associated with candidate cell or candidate target cell or target cell or serving cell.

In some implementations, CSI-RS or TRS or CSI-RS for tracking can be configured as QCL source/reference RS in TCI state. Wherein, whether CSI-RS or TRS or CSI-RS for tracking can be configured as QCL source/reference RS in TCI state depends on UE capability. Optionally, whether CSI-RS or TRS or CSI-RS for tracking can be configured as QCL source/reference RS in TCI state before cell switch command.

In some implementations, CSI-RS related configuration associated with or corresponding to CSI-RS index or TRS index or CSI-RS for tracking index indicated in TCI state can be configured or not configured. Optionally, whether CSI-RS related configuration associated with or corresponding to CSI-RS index or TRS index or CSI-RS for tracking index indicated in TCI state is configured depends on UE capability. Optionally, CSI-RS related configuration associated with or corresponding to CSI-RS index or TRS index or CSI-RS for tracking index indicated in TCI state can be configured but at least one of it is not enabled or is not allowed to be applied, or no specific information or IE is included in CSI-RS related configuration.

In some implementations, during or when receiving cell switch command (CSC), at least one of the following can be considered for CSI-RS for tracking or TRS:
Scheme-1: TCI state indicating or including QCL type with TRS or CSI-RS for tracking or CSI-RS can be applied for UE to measure and/or track CSI-RS or TRS or CSI-RS for tracking. Optionally, it can be for the case that CSI-RS or TRS or CSI-RS for tracking is triggered or indicated in cell switch command, and/or, CSI-RS or TRS or CSI-RS for tracking is not allowed or not completed before cell switch command, and/or, SSB associated with CSI-RS or TRS or CSI-RS for tracking is measured and/or tracked and/or maintained before cell switch command, and/or, CSI-RS or TRS or CSI-RS for tracking related information associated with CSI-RS index or TRS index or CSI-RS index for tracking is configured or acquired from configuration corresponding to cell index indicated in cell switch command.
Scheme-2: CSI-RS or TRS or CSI-RS for tracking can be performed and/or tracked by a field to trigger CSI-RS or TRS or CSI-RS for tracking in cell switch command.
Scheme-3: TCI state indicating or including QCL type with SSB can be applied for UE to measure and/or track CSI-RS or TRS or CSI-RS for tracking associated with SSB.

In some implementations, at least one of the following can be considered:

Note that TCI state can be indicated TCI state in cell switch command, and/or, activated or selected TCI state, and/or, a TCI state that is not in activated or selected TCI state(s) before or in cell switch command.

In some implementations, CSI-RS related information or configuration can be is configured or acquired from configuration corresponding to cell index indicated in cell switch command, or indicated by cell switch command. In some implementations, CSI-RS related information includes at least one of offset, the number of CSI-RS resource, the number of CSI-RS resource set, the gap between CSI-RS resource, the gap between CSI-RS resource set, information of frequency domain. Optionally, offset is an interval or time from starting or ending of receiving cell switch command or decoding cell switch command or cell configuration in cell switch command to start of CSI-RS resource or CSI-RS resource set.

In some implementations, after receiving cell switch command (CSC), at least one of the following can be considered for CSI-RS for tracking or TRS:
Scheme-1: CSI-RS or TRS or CSI-RS for tracking can be performed and/or tracked by a signaling to trigger CSI-RS or TRS or CSI-RS for tracking and/or indicate CSI-RS related information after cell switch command.
Scheme-2: TCI state indicating or including QCL type with TRS or CSI-RS for tracking or CSI-RS can be applied for UE to measure and/or track CSI-RS or TRS or CSI-RS for tracking after cell switch command. Optionally, it can be for the case of CSI-RS related configuration associated with or corresponding to CSI-RS index or TRS index or CSI-RS for tracking index indicated in TCI state is configured or acquired, and/or, TRS or CSI-RS for tracking or CSI-RS is enabled or is allowed during/after cell switch command.
Scheme-3: TCI state indicating or including QCL type with SSB can be applied for UE to measure and/or track CSI-RS or TRS or CSI-RS for tracking associated with SSB. Optionally, it is for the case of CSI-RS or TRS or CSI-RS for tracking after cell switch command, and/or, CSI-RS related configuration associated with or corresponding to CSI-RS or TRS or CSI-RS for tracking is configured or acquired, and/or, TRS or CSI-RS for tracking or CSI-RS is enabled or is allowed during/after cell switch command.

Note that TCI state can be indicated TCI state in cell switch command, and/or, activated or selected TCI state, and/or, a TCI state that is not in activated or selected TCI state(s) before or in or after cell switch command.

If TRS tracking for candidate cells is not supported before and/or during cell switch command and SSB and/or TRS can be configured as QCL source RS in TCI state for candidate cell(s) before and/or during cell switch command, at least one of the following implementations can be considered:

Before/during receiving cell switch command, the UE only needs to track SSB indicated in activated and/or indicated TCI state.

After receiving cell switch command, the UE can identify a TRS based on the TRS index indicated in TCI state, and/or then track the corresponding TRS. Optionally, the TCI state can be indicated TCI state in cell switch command, or activated and/or indicated TCI state after cell switch command.

Optionally, SSB index is mandatorily configured in TCI state, regardless of whether TRS index is configured or not.

Optionally, TRS index is optionally configured in TCI state.

In some implementations, at least one of the following implementations can be considered:

Before/during receiving cell switch command, the UE does not identify TRS based on TRS index indicated in activated and/or indicated TCI state. Optionally, UE does not track TRS.

After receiving cell switch command, the UE can identify a TRS based on the TRS index indicated in TCI state, and then track the corresponding TRS.

In some implementations, at least one of the following implementations can be considered:

Before/during receiving cell switch command, the UE only needs to track SSB indicated in activated and/or indicated TCI state.

After receiving cell switch command, the UE can identify a TRS associated with SSB index indicated in TCI state, and/or then track the corresponding TRS.

Note that specific CSI-RS resource corresponding to the TRS in TCI state is obtained by serving cell configuration corresponding to target cell index indicated in cell switch command.

Note that SSB and/or TRS can be mandatory or optional in TCI state for at least one of the above mentioned methods.

If TRS tracking for candidate cells is supported before and/or during and/or after cell switch command, if SSB and/or TRS can be configured as QCL source RS in TCI state for candidate cell(s) before and/or during and/or after cell switch command, at least one of the following should be considered:

Before/during receiving cell switch command, the UE can identify and/or track TRS indicated in activated and/or indicated TCI state, or, the UE can identify and/or track SSB and/or TRS indicated in activated and/or indicated TCI state.

After receiving cell switch command, the UE can identify SSB and/or TRS based on the SSB index and/or TRS index indicated in TCI state, and/or then track the corresponding SSB and/or TRS.

Optionally, the TCI state can be indicated TCI state in cell switch command, or activated and/or indicated TCI state after cell switch command.

Optionally, TRS index is mandatorily configured in TCI state.

Optionally, SSB index is optionally or mandatorily configured in TCI state.

Optionally, TRS can be associated with a SSB.

Optionally, for at least one of the above mentioned, SSB and TRS can be configured in the same TCI state, or in different TCI state, respectively.

Optionally, for at least one of the above mentioned, SSB and/or TRS is configured as QCL source with the same or different QCL type in a TCI state.

The CSI-RS related configuration or information as discussed above can be applied to other embodiments.

Note that the above QCL type can be at least one of QCL type A, QCL type B, QCL type C, QCL type D.

How to determine or obtain relationship or information between CSI-RS index indicated in TCI state and CSI-RS configuration can be found in at least one of following example embodiments.

CSI-RS configuration or information can be configured or acquired by RRC signaling or pre-configuration or MAC CE signaling to convey cell switch command or configuration information corresponding to cell index indicated in MAC CE signaling to convey cell switch command. In some situations, some CSI-RS configuration can be configured or acquired before cell switch command, other CSI-RS configuration can be configured or acquired in configuration corresponding to cell index or target cell index indicated in cell switch command.

In this document, cell switch command is used to convey information to UE, such as at least one of TCI state index, cell index, BWP index, triggering and/or indication of CSI-RS for tracking, Timing advance, RACH indication, triggering or indication of CSI-RS for CSI acquisition, activation of TCI state, indication to enable CSI-RS for tracking or TRS, etc. Optionally, signaling to activate or select TCI state can be same or different with that of signaling of cell switch command. Optionally, TCI state activation can be done before or in cell switch command. Optionally, the signaling can be at least one of RRC signaling, MAC CE signaling, DCI signaling.

### Example Embodiment 2

Regarding CSI-RS configuration, at least one of the following can be considered:
Option 1: CSI-RS configuration without specific information on CSI-RS or CSI-RS for tracking or TRS is configured before receiving cell switch command.
Option 2: Information set #1 on CSI-RS or CSI-RS for tracking or TRS, or, CSI-RS configuration including information set #1 on CSI-RS or CSI-RS for tracking or TRS is configured before cell switch command.
Option 3: Information set #2 on CSI-RS or CSI-RS for tracking or TRS, or, CSI-RS configuration including information set #2 on CSI-RS or CSI-RS for tracking or TRS is configured or acquired in configuration corresponding to cell index or target cell index indicated or obtained by cell switch command.
Option 4: Information set #3 on CSI-RS or CSI-RS for tracking or TRS, or, CSI-RS configuration including information set #3 on CSI-RS or CSI-RS for tracking or TRS is indicated and/or triggered by a signaling. Wherein, the signaling can be at least one of RRC signaling, MAC CE signaling, DCI signaling.

Optionally, CSI-RS configuration, or, CSI-RS configuration including information set #1 on CSI-RS or CSI-RS for tracking or TRS, information set #1 CSI-RS or CSI-RS for tracking or TRS, or, CSI-RS configuration including information set #2 on CSI-RS or CSI-RS for tracking or TRS, information set #2 CSI-RS or CSI-RS for tracking or TRS, or, CSI-RS configuration including information set #3 on CSI-RS or CSI-RS for tracking or TRS, information set #3 CSI-RS or CSI-RS for tracking or TRS, or, CSI-RS configuration including information set #4 on CSI-RS or CSI-RS for tracking or TRS, information set #4 CSI-RS or CSI-RS for tracking or TRS, includes at least one of the following CSI-RS resource ID, frequency domain allocation within a physical resource block, the number of ports, time domain allocation within a physical resource block, CDM type, density of CSI-RS resource measured in RE/port/PRB, starting of CSI-RS in frequency domain, number of PRBs across which CSI-RS resource spans in frequency domain, the offset of power control, scramblingID, periodicity, offset within periodicity, RS index, TCI state ID, CSI-RS resource set ID, CSI-RS resource ID(s) associated with CSI-RS resource set ID, cell index, offset between DCI that triggers aperiodic CSI-RS resource and CSI-RS transmission, offset to indicate CSI-RS transmission resource, an indication of CSI-RS for tracking, BWP index, RACH configuration, SRS information, subcarrier spacing, frequency, point A, Reference cell ID, or others.

In this document, CSI-RS configuration, CSI-RS resource configuration, or CSI-RS resource set configuration can be referred to as CSI-RS related configuration.

CSI-RS related configuration/information or CSI-RS configuration or CSI-RS configuration including information sets #1 to #3 can refer to embodiment 5 and/or embodiment 2-1 to 2-4.

Each option will be further discussed in detail below.

Information sets #1 to #3 refer to the information sets configurated or indicated/triggered under Options 2-4, respectively.

### Example Embodiment 2-1 for Option 1

As mentioned above, under Option 1, no specific information on CSI-RS or CSI-RS for tracking or TRS is configured in at least one of CSI-RS configuration, CSI-RS resource configuration, or CSI-RS resource set configuration.

At least one of the following behaviors or rules can be considered for option 1 of Example Embodiment 2:
CSI-RS configuration or CSI-RS resource configuration or CSI-RS resource set configuration is provided or configured by RRC before cell switch command where this configuration does not include specific CSI-RS related configuration information. Optionally, an indication of TRS tracking or trs-info can be configured or enabled or set to “true”, or not configured or enabled or set to “true”.
A signalling activates one or multiple TCI states. E.g., {TCI state #x_1, TCI state #x_2, TCI state #x_3, . . . , TCI state #x_a, TCI state #y_1, TCI state #y_2, TCI state #y_3, . . . TCI state #y_b}. The signaling can be at least one of RRC signaling, MAC CE signaling, DCI signaling. Assumed that TCI state #X_i includes or indicates SSB or CSI-RS or TRS as QCL source, TCI state #Y_t includes or indicates SSB or CSI-RS or TRS as QCL source. Optionally, i is 1, 2, 3, . . . , a. t is 1, 2, 3 . . . b. a or b is an integer. Minimum value of a or b is 0 or 1. the maximum value of a or b or a plus b is any of 2, 3, 4, 5, 6, 7, 8 . . . 1024.
CSI-RS index indicated in TCI state #Y_t is associated with or related to or corresponds to CSI-RS configuration or CSI-RS related configuration or one or multiple CSI-RS resource index, or CSI-RS resource set index, CSI-RS resource within a CSI-RS resource set. Optionally, CSI-RS resource index, or CSI-RS resource set index, CSI-RS resource within a CSI-RS resource set does not includes specific information on CSI-RS or TRS or CSI-RS for tracking.
At least one of the following implementations can be considered:
   In some implementations, UE cannot or does not track or measure CSI-RS for tracking before cell switch command. The reason is UE cannot track CSI-RS for tracking related information associated with or related to or corresponds to CSI-RS index in TCI sate. While only can know or obtain CSI-RS configuration index without specific CSI-RS related information associated with or related to or corresponds to CSI-RS index in TCI sate.
   In some implementations, UE can track and/or measure SSB for tracking before and/or during and/or after cell switch command.
   Another possible way is UE performs time and frequency sync by SSB, rather than CSI-RS for tracking.
   In some implementations, UE can track and/or measure SSB until CSI-RS for tracking or TRS is done or enabled or allowed or configured. Optionally, such operation can be before and/or during and/or after cell switch command. Optionally, SSB is associated with CSI-RS for tracking or TRS or CSI-RS.
   In some implementations, UE can measure and/or track CSI-RS or TRS or CSI-RS for tracking based on CSI-RS configuration included in RRC configuration associated with or corresponding to cell index or target cell index indicated in cell switch command, or CSI-RS configuration is configured or acquired or allowed during or after cell switch command.
      Optionally, TCI state or CSI-RS index indicated in a TCI state or TCI state index indicated in cell switch command is associated with or related to or corresponds to one or multiple CSI-RS resource index, or CSI-RS resource set index, CSI-RS resource within a CSI-RS resource set configured in RRC configuration associated with or corresponding to cell index or target cell index indicated in cell switch command or CSI-RS configuration is configured or acquired or allowed during or after cell switch command.
      Optionally, SSB index indicated in a TCI state activated or selected by a signaling or SSB index is associated with CSI-RS index indicated in a TCI state or TCI state indicated in cell switch command, or associated with a TCI state indicated in cell switch command. Optionally, CSI-RS related configuration corresponding to CSI-RS index indicated in a TCI state, or TCI state or indicated TCI state index in cell switch command is configured or contained or obtained in RRC configuration associated with or corresponding to cell index or target cell index indicated in cell switch command, or CSI-RS configuration is configured or acquired or allowed during or after cell switch command. Based on the above information, UE can perform CSI-RS for tracking, or, measure and/or track CSI-RS or TRS.
      Optionally, SSB index indicated in a TCI state or TCI state indicated in cell switch command is associated with or related to or corresponds to one or multiple CSI-RS resource index, or CSI-RS resource set index, CSI-RS resource within a CSI-RS resource set configured in RRC configuration associated with or corresponding to cell index or target cell index indicated in cell switch command, or CSI-RS configuration is configured or acquired or allowed during or after cell switch command. Based on the above information, UE can perform CSI-RS for tracking, or, measure and/or track CSI-RS or TRS.
      Optionally, CSI-RS index indicated in a TCI state activated by a signaling or TCI state index activated by a signaling is associated with or related to or corresponds to one or multiple CSI-RS resource index, or CSI-RS resource set index, CSI-RS resource within a CSI-RS resource set configured in RRC configuration associated with or corresponding to cell index or target cell index indicated in cell switch command, or CSI-RS configuration is configured or acquired or allowed during or after cell switch command.

### Example Embodiment 2-2 for Option 2

As described above, under Option 2, information set #1 is configured in at least one of CSI-RS configuration, CSI-RS resource configuration, or CSI-RS resource set configuration. or, information set #1 on CSI-RS or CSI-RS for tracking or TRS, or, CSI-RS configuration including information set #1 on CSI-RS or CSI-RS for tracking or TRS is configured before cell switch command.

In some implementations, information set #1 on CSI-RS or CSI-RS for tracking or TRS, or, CSI-RS configuration including information set #1 on CSI-RS or CSI-RS for tracking or TRS includes at least one of the following CSI-RS resource ID, frequency domain allocation within a physical resource block, the number of ports, time domain allocation within a physical resource block, CDM type, density of CSI-RS resource measured in RE/port/PRB, starting of CSI-RS in frequency domain, number of PRBs across which CSI-RS resource spans in frequency domain, the offset of power control, scramblingID, periodicity, offset within periodicity, RS index, TCI state ID, CSI-RS resource set ID, CSI-RS resource ID(s) associated with CSI-RS resource set ID, cell index, offset between DCI that triggers aperiodic CSI-RS resource and CSI-RS transmission, offset to indicate CSI-RS transmission resource, an indication of CSI-RS for tracking, BWP index, RACH configuration, SRS information, subcarrier spacing, frequency, point A, Reference cell ID, or others.

In some implementations, information set #1 on CSI-RS or CSI-RS for tracking or TRS, or CSI-RS configuration including information set #1 on CSI-RS or CSI-RS for tracking or TRS can be configured but not enabled or activated, and/or, CSI-RS for tracking or TRS is not allowed or configured before cell switch command. In some other implementations, information set #1 on CSI-RS or CSI-RS for tracking or TRS, or, CSI-RS configuration including information set #1 on CSI-RS or CSI-RS for tracking or TRS is configured and partial or all of them are enabled or effective or activated.

At least one of the following behaviors or rules can be considered for Option 2 of Example Embodiment 2:
CSI-RS configuration is provided or configured by RRC before cell switch command.
   CSI-RS configuration includes at least one of CSI-RS resource ID, Frequency domain allocation within a physical resource block, the number of ports, Time domain allocation within a physical resource block, CDM type, Density of CSI-RS resource measured in RE/port/PRB, starting of CSI-RS in frequency domain, Number of PRBs across which CSI-RS resource spans in frequency domain, the offset of power control, scramblingID, periodicity, offset within periodicity, RS index, TCI state ID, CSI-RS resource set ID, CSI-RS resource ID(s) associated with CSI-RS resource set ID, cell index, offset between DCI that triggers aperiodic CSI-RS resource and CSI-RS transmission, offset to indicate CSI-RS transmission resource, an indication of CSI-RS for tracking, BWP index, RACH configuration, SRS information, subcarrier spacing, Frequency, point A, Reference cell ID, or others.
   In some implementations, once CSI-RS configuration is configured, corresponding information is enabled or effective or activated. In some implementations, CSI-RS configuration takes effect based on at least one of whether TCI state associated with corresponding to CSI-RS configuration is activated, whether RS index associated with corresponding to CSI-RS configuration is included in activated TCI state, receiving of cell switch command, or TCI state activation, or CSI-RS for tracking or TRS is allowed.
A signalling activates one or multiple TCI states. E.g., {TCI state #x_1, TCI state #x_2, TCI state #x_3, . . . , TCI state #x_a, TCI state #y_1, TCI state #y_2, TCI state #y_3, . . . , TCI state #y_b}. wherein, the signaling can be at least one of RRC signaling, MAC CE signaling, DCI signaling. Assuming that TCI state #X_i includes or indicates SSB or CSI-RS or CSI-RS for tracking or TRS as QCL source, TCI state #Y_t includes or indicates CSI-RS or SSB or CSI-RS for tracking or TRS as QCL source. Optionally, i is 1, 2, 3, . . . , a. t is 1, 2, 3, . . . b. a or b is an integer. Minimum value of a or b is 0 or 1. the maximum value of a or b or a plus b is any of 2, 3, 4, 5, 6, 7, 8, . . . 1024.
CSI-RS index indicated in TCI state #Y_t is associated with or related to or corresponds to one or multiple CSI-RS resource index, or CSI-RS resource set index, CSI-RS resource within a CSI-RS resource set included in CSI-RS configuration.
At least one of the following implementations can be considered:
   Optionally, once CSI-RS configuration is configured, corresponding information is enabled or effective or activated.
   In some implementations, if CSI-RS for tracking is allowed to be done before cell switch command, then UE can measure and/or track or perform CSI-RS for tracking based on CSI-RS configuration associated with or corresponding to or related to RS index indicated in activated TCI state.
   In some other implementations, if CSI-RS for tracking is not allowed to be done before cell switch command, then UE cannot measure and/or track or perform CSI-RS for tracking based on CSI-RS configuration associated with or corresponding to or related to RS index indicated in activated TCI state.
   In some other implementations, if CSI-RS for tracking is not allowed to be done before cell switch command, then UE can measure and/or track or perform CSI-RS for tracking based on CSI-RS configuration associated with or corresponding to or related to RS index indicated in activated TCI state or TCI state index in activated TCI states before or during and/or in cell switch command. Optionally, CSI-RS configuration can be updated by RRC configuration corresponding to a cell index or target cell index indicated in cell switch command.
   In some other implementations, if CSI-RS for tracking is not allowed to be done before cell switch command, UE can measure and/or track or perform SSB indicated in activated TCI state, or SSB associated with TRS or CSI-RS for tracking or CSI-RS indicated in activated TCI state. Optionally, such operation is to achieve fine time and frequency sync. Optionally, the SSB is associated with or related to or corresponds to one or multiple CSI-RS resource index, or CSI-RS resource set index, CSI-RS resource within a CSI-RS resource set.
At least one of the following implementations can be considered:
   Optionally, CSI-RS configuration takes effect based on whether TCI state associated with corresponding to CSI-RS configuration is activated or selected.
   If TCI state index associated with or related to or corresponding to CSI-RS configuration is in activated TCI states, or TCI state index including RS index associated with or related to or corresponding to CSI-RS configuration is in activated TCI states, the following implementations are considered.
      In some implementations, If CSI-RS for tracking or CSI-RS or TRS is allowed to be done before cell switch command, UE can measure and/or track or perform CSI-RS for tracking based on CSI-RS configuration associated with or corresponding to or related to RS index indicated in activated TCI state or TCI state index in activated TCI states.
      In some other implementations, if CSI-RS for tracking or CSI-RS or TRS is not allowed to be done before cell switch command, UE cannot measure and/or track or perform CSI-RS for tracking based on CSI-RS configuration associated with or corresponding to or related to RS index indicated in activated TCI state or TCI state index in activated TCI states.
      In some other implementations, if CSI-RS for tracking or CSI-RS or TRS is not allowed to be done before cell switch command, UE can measure and/or track or perform CSI-RS for tracking based on CSI-RS configuration associated with or corresponding to or related to RS index indicated in activated TCI state or TCI state index in activated TCI states before or during and/or in or after cell switch command. Optionally, CSI-RS configuration can be updated by RRC configuration corresponding to a cell index or target cell index indicated in cell switch command.
      In some other implementations, if CSI-RS for tracking or CSI-RS or TRS is not allowed to be done before cell switch command, UE can measure and/or track or perform SSB indicated in activated TCI state or associated with CSI-RS index or CSI-RS index indicated in TCI state. Optionally, such operation is to achieve fine time and frequency sync. Optionally, the SSB or CSI-RS or TRS or CSI-RS for tracking is associated with or related to or corresponds to one or multiple CSI-RS resource index, or CSI-RS resource set index, CSI-RS resource within a CSI-RS resource set.
   At least one of the following implementations are considered:
      Optionally, If TCI state index associated with or related to or corresponding to CSI-RS configuration is not in activated TCI states, or TCI state index including RS index associated with or related to or corresponding to CSI-RS configuration is not in activated TCI states.
      UE cannot measure and/or track or perform CSI-RS for tracking based on CSI-RS configuration. or
      UE can measure and/or track or perform CSI-RS for tracking based on CSI-RS configuration. or
      UE does not expect that TCI state index associated with or related to or corresponds to CSI-RS configuration is not in activated or indicated TCI states, or TCI state index including RS index associated with or related to or corresponds to CSI-RS configuration is not in activated or indicated TCI states. or
      UE can measure and/or track or perform RS index indicated in activated or indicated TCI state or associated with CSI-RS index or CSI-RS index. Wherein, RS index can be SSB or CSI-RS or CSI-RS for tracking or TRS.
At least one of the following implementations can be considered
   Optionally, when CSI-RS configuration takes effect based on whether RS index associated with corresponding to CSI-RS configuration is included in activated or indicated TCI state. or
   In some implementations, if CSI-RS for tracking or CSI-RS or TRS is allowed to be done before cell switch command, UE can measure and/or track or perform CSI-RS for tracking based on CSI-RS configuration associated with or corresponding to or related to RS index indicated in activated or indicated TCI state or TCI state index in activated or indicated TCI states.
   In some other implementations, if CSI-RS for tracking or CSI-RS or TRS is not allowed to be done before cell switch command, UE cannot measure and/or track or perform CSI-RS for tracking based on CSI-RS configuration associated with or corresponding to or related to RS index indicated in activated or indicated TCI state or TCI state index in activated or indicated TCI states.
   In some other implementations, if CSI-RS for tracking or CSI-RS or TRS is not allowed to be done before cell switch command, UE can measure and/or track or perform CSI-RS for tracking based on CSI-RS configuration associated with or corresponding to or related to RS index indicated in activated or indicated TCI state or TCI state index in activated or indicated TCI states before or during and/or in or before cell switch command. Optionally, CSI-RS configuration can be updated by RRC configuration corresponding to a cell index or target cell index indicated in cell switch command.
   In some other implementations, if CSI-RS for tracking or CSI-RS or TRS is not allowed to be done before cell switch command, UE can measure and/or track or perform SSB indicated in activated TCI state or associated with CSI-RS index or CSI-RS index indicated in TCI state. Optionally, such operation is to achieve fine time and frequency sync. Optionally, the SSB or CSI-RS or CSI-RS for tracking or TRS is associated with or related to or corresponds to one or multiple CSI-RS resource index, or CSI-RS resource set index, CSI-RS resource within a CSI-RS resource set.
At least one of the following scenarios can be considered:
   Optionally, CSI-RS configuration takes effect based on receiving of cell switch command.
   UE does not measure and/or track or perform CSI-RS for tracking based on CSI-RS configuration associated with or corresponding to or related to RS index indicated in activated TCI state or TCI state index in activated TCI states before cell switch command.
   UE can measure and/or track or perform SSB indicated in activated TCI state or associated with CSI-RS index or CSI-RS index indicated in TCI state before/during/after cell switch command. Optionally, such operation is to achieve fine time and frequency sync. Optionally, the SSB is associated with or related to or corresponds to one or multiple CSI-RS resource index, or CSI-RS resource set index, CSI-RS resource within a CSI-RS resource set in CSI-RS configuration.
   UE can measure and/or track or perform CSI-RS for tracking based on CSI-RS configuration associated with or corresponding to or related to RS index indicated in TCI state or TCI state index indicated in cell switch command. Optionally, CSI-RS configuration can be updated by RRC configuration corresponding to a cell index or target cell index indicated in cell switch command.
At least one of the following scenarios can be considered:
   Optionally, CSI-RS configuration takes effect based on TCI state activation.
   In some implementations, if CSI-RS for tracking or CSI-RS or TRS is allowed to be done before cell switch command, UE can measure and/or track or perform CSI-RS for tracking based on CSI-RS configuration associated with or corresponding to or related to RS index indicated in activated TCI state or TCI state index in activated TCI states.
   In some other implementations, if CSI-RS for tracking or CSI-RS or TRS is not allowed to be done before cell switch command, UE cannot measure and/or track or perform CSI-RS for tracking based on CSI-RS configuration associated with or corresponding to or related to RS index indicated in activated TCI state or TCI state index in activated TCI states.
   In some other implementations, if CSI-RS for tracking or CSI-RS or TRS is not allowed to be done before cell switch command, UE can measure and/or track or perform CSI-RS for tracking based on CSI-RS configuration associated with or corresponding to or related to RS index indicated in activated or indicated TCI state or TCI state index in activated or indicated TCI states before or during and/or in or after cell switch command. Optionally, CSI-RS configuration can be updated by RRC configuration corresponding to a cell index or target cell index indicated in cell switch command.
   If CSI-RS for tracking or CSI-RS or TRS is not allowed to be done before cell switch command, UE can measure and/or track or perform SSB indicated in activated TCI state or associated with CSI-RS index or CSI-RS index indicated in TCI state. Optionally, such operation is to achieve fine time and frequency sync. Optionally, the SSB or CSI-RS or CSI-RS for tracking or TRS is associated with or related to or corresponds to one or multiple CSI-RS resource index, or CSI-RS resource set index, CSI-RS resource within a CSI-RS resource set.

### Example Embodiment 2-3 for Option 3

As described above, under Option 3, information set #2 is configured in serving cell indicated or obtained by cell switch command. Or Information set #2 on CSI-RS or CSI-RS for tracking or TRS, or, CSI-RS configuration including information set #2 on CSI-RS or CSI-RS for tracking or TRS is configured or acquired in configuration corresponding to cell index or target cell index indicated or obtained by cell switch command.

In some implementations, information set #2 or CSI-RS configuration includes at least one of CSI-RS resource ID, frequency domain allocation within a physical resource block, the number of ports, time domain allocation within a physical resource block, CDM type, density of CSI-RS resource measured in RE/port/PRB, starting of CSI-RS in frequency domain, number of PRBs across which CSI-RS resource spans in frequency domain, the offset of power control, scramblingID, periodicity, offset within periodicity, RS index, TCI state ID, CSI-RS resource set ID, CSI-RS resource ID(s) associated with CSI-RS resource set ID, cell index, offset between DCI that triggers aperiodic CSI-RS resource and CSI-RS transmission, offset to indicate CSI-RS transmission resource, an indication of CSI-RS for tracking, BWP index, RACH configuration, SRS information, subcarrier spacing, frequency, point A, reference cell ID, or others.

In some implementations, information set #2 or CSI-RS configuration is obtained by configuration associated with or corresponding to a cell index or a target cell index indicated in cell switch command.

At least one of the following behaviors or rules can be considered for Option 3 of Example Embodiment 2:

CSI-RS configuration is provided or configured in serving cell indicated or obtained by cell switch command or by configuration associated with or corresponding to a cell index or a target cell index indicated in cell switch command.
CSI-RS configuration includes at least one of CSI-RS resource ID, Frequency domain allocation within a physical resource block, the number of ports, Time domain allocation within a physical resource block, CDM type, Density of CSI-RS resource measured in RE/port/PRB, starting of CSI-RS in frequency domain, Number of PRBs across which CSI-RS resource spans in frequency domain, the offset of power control, scramblingID, periodicity, offset within periodicity, RS index, TCI state ID, CSI-RS resource set ID, CSI-RS resource ID(s) associated with CSI-RS resource set ID, cell index, offset between DCI that triggers aperiodic CSI-RS resource and CSI-RS transmission, offset to indicate CSI-RS transmission resource, an indication of CSI-RS for tracking, BWP index, RACH configuration, SRS information, subcarrier spacing, Frequency, point A, Reference cell ID, or others.
A signalling activates one or multiple TCI states. E.g., {TCI state #x_1, TCI state #x_2, TCI state #x_3, . . . , TCI state #x_a, TCI state #y_1, TCI state #y_2, TCI state #y_3, . . . , TCI state #y_b}. wherein, the signaling can be at least one of RRC signaling, MAC CE signaling, DCI signaling. Assuming that TCI state #X_i includes or indicates SSB or CSI-RS or CSI-RS for tracking or TRS as QCL source, TCI state #Y_t includes or indicates CSI-RS or SSB or CSI-RS for tracking or TRS as QCL source. Optionally, i is 1, 2, 3, . . . a. t is 1, 2, 3, . . . b. a or b is an integer. Minimum value of a or b is 0 or 1. the maximum value of a or b or a plus b is any of 2, 3, 4, 5, 6, 7, 8, . . . 1024.
CSI-RS index indicated in TCI state #Y_t is associated with or related to or corresponds to one or multiple CSI-RS resource index, or CSI-RS resource set index, CSI-RS resource within a CSI-RS resource set in CSI-RS configuration provided or configured in serving cell indicated or obtained by cell switch command, or configuration associated with or corresponding to a cell index or a target cell index indicated in cell switch command.
At least one of the followings can be implemented:
   UE does not measure and/or track or perform CSI-RS for tracking based on CSI-RS index indicated in activated TCI state before cell switch command.
   UE can measure and/or track or perform SSB indicated in activated TCI state or associated with CSI-RS index or CSI-RS index indicated in TCI state before/during/after cell switch command. Optionally, such operation is to achieve fine time and frequency sync. Optionally, the SSB is associated with or related to or corresponds to one or multiple CSI-RS resource index, or CSI-RS resource set index, CSI-RS resource within a CSI-RS resource set in CSI-RS configuration.
   UE can measure and/or track or perform CSI-RS for tracking based on CSI-RS configuration associated with or corresponding to or related to RS index indicated in TCI state indicated in cell switch command, or TCI state index indicated in cell switch command, or acquired by configuration corresponding to a cell index or target cell index indicated in cell switch command.

### Example Embodiment 2-4 for Option 4

As described above, under Option 4, information set #3 is indicated and/or triggered by a signaling, or information set #3 on CSI-RS or CSI-RS for tracking or TRS, or, CSI-RS configuration including information set #3 on CSI-RS or CSI-RS for tracking or TRS is indicated and/or triggered by a signaling.

In some implementations, the signaling can be at least one of MAC CE signaling or DCI signaling, RRC signaling.

In some implementations, information set #3 includes at least one of offset between signaling and CSI-RS transmission, the number of CSI-RS resource or CSI-RS resource set, time gap between CSI-RS resources or CSI-RS resource set, indication to trigger CSI-RS transmission, and so on.

Note that for any of Option 1 to Option 4, which are mentioned above, TCI state ID or RS index or RS index in TCI state is associated with or related to or corresponds to one or multiple CSI-RS resource index, or CSI-RS resource set index, CSI-RS resource within a CSI-RS resource set, and/or cell index.

At least one of the following behavior or rule can be considered for option 4 of Example Embodiment 2:
A signaling triggers CSI-RS for tracking and indicates CSI-RS information.
At least one of the following:
   In some implementations, the same signaling indicates at least one of CSI-RS related information or offset to CSI-RS transmission.
   In some implementations, another signaling is used to indicate at least one of CSI-RS related information or offset to CSI-RS transmission.
   In some implementations, CSI-RS related information is associated to or related to or corresponding to or obtained by configuration information corresponding to a cell index or target cell index indicated in or after cell switch command
   In some implementations, the signaling can be at least one of MAC CE signaling, DCI signaling, RRC signaling.
CSI-RS related information includes at least one of offset between signaling and CSI-RS transmission, the number of CSI-RS resource or CSI-RS resource set, time gap between CSI-RS resources or CSI-RS resource set, indication to trigger CSI-RS transmission, CSI-RS resource ID, Frequency domain allocation within a physical resource block, the number of ports, Time domain allocation within a physical resource block, CDM type, Density of CSI-RS resource measured in RE/port/PRB, starting of CSI-RS in frequency domain, Number of PRBs across which CSI-RS resource spans in frequency domain, the offset of power control, scramblingID, periodicity, offset within periodicity, RS index, TCI state ID, CSI-RS resource set ID, CSI-RS resource ID(s) associated with CSI-RS resource set ID, cell index, offset between DCI that triggers aperiodic CSI-RS resource and CSI-RS transmission, offset to indicate CSI-RS transmission resource, an indication of CSI-RS for tracking, BWP index, RACH configuration, SRS information, subcarrier spacing, Frequency, point A, Reference cell ID and so on.

Based on any of the above information, UE can measure and/or track or perform CSI-RS for tracking.

### Example Embodiment 3

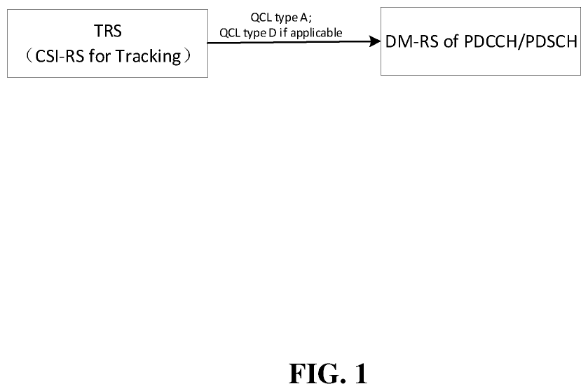

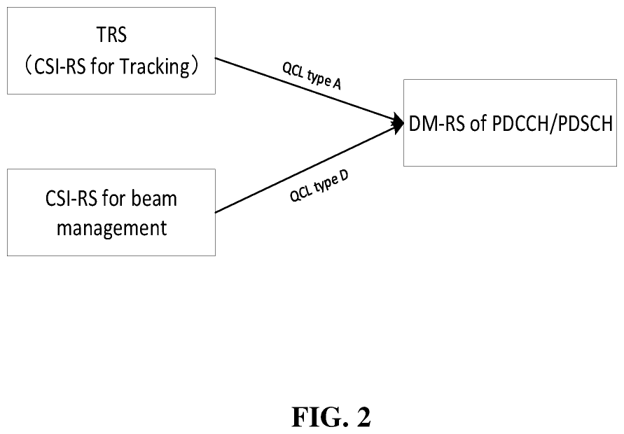

In legacy specification, for the DM-RS of PDCCH or PDSCH, the UE shall expect that a TCI-State indicates QCL type A with TRS, and QCL type D with the same TRS when applicable, as shown in FIG. 1. FIG. 1 illustrates TRS with QCL type A and QCL type D that are indicated by TCI state for DMRS of PDCCH/PDSCH. In some implementations, the UE shall expect that a TCI-State indicates QCL type A with TRS, and QCL type D with a CSI-RS in an NZP-CSI-RS-ResourceSet configured with higher layer parameter repetition when applicable, as shown in FIG. 2 that illustrates TRS with QCL type A and CSI-RS for beam management (BM) with QCL type D indicated by TCI state for DMRS of PDCCH or PDSCH.

According to the above information, TRS is required as a reference or resource RS with QCL-Type A and/or QCL-Type D in a TCI state for the DM-RS of PDSCH and PDCCH.

Whether TRS can be used as QCL source RS in a TCI state or CSI-RS for tracking is allowed before cell switch will depend on or be up to UE capability. In some implementations, even if UE reports to have such capability, network or base station can decide or control whether to configure or indicate CSI-RS or TRS related configuration or functionality to UE.

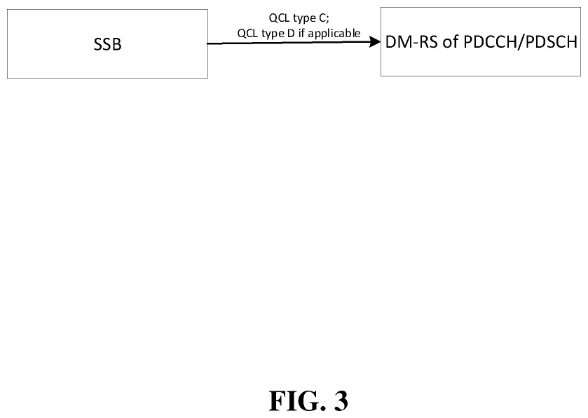

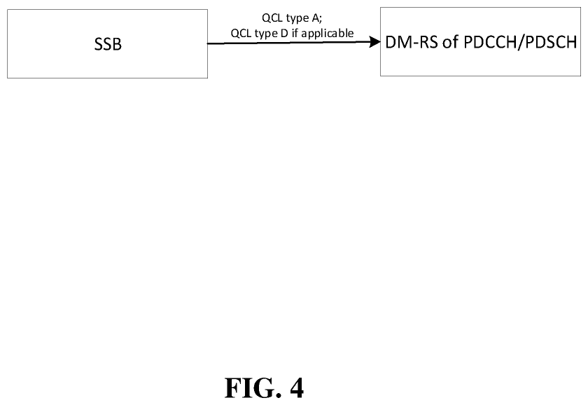

At least one of the following can be considered for DMRS of PDCCH or PDCCH:
Scheme-1: UE shall expect that a TCI state indicates QCL type C with SSB and QCL type D with SSB if applicable, as shown in FIG. 3. FIG. 3 illustrates a SSB with QCL type C and QCL type D that are indicated by a TCI state for DMRS of PDCCH/PDSCH. In some implementations, UE shell expect that a TCI state indicates SSB with regard to QCL-TypeC and SSB with regard to QCL-TypeD, if applicable in a QCL-Info of the TCI state can be considered for DM-RS of PDSCH and PDCCH.
Scheme-2: UE shall expect that a TCI state indicates QCL type A with SSB and QCL type D with SSB if applicable, as shown in FIG. 4. FIG. 4 illustrates a SSB with QCL type A and QCL type D that are indicated by a TCI state for DMRS of PDCCH/PDSCH In some implementations, UE shell expect that a TCI state indicates a SSB with regard to QCL-TypeA and SSB with regard to QCL-TypeD, if applicable in a QCL-Info of the TCI state can be considered for DM-RS of PDSCH and PDCCH.

Note that for scheme-1 or scheme-2, it can be applied for the case that SSB is configured as QCL source or reference RS in TCI state or if SSB is configured. Where SSB is associated with candidate cell or candidate target cell or target cell or serving cell.
Scheme-3: UE shall expect that a TCI state indicates QCL type A with TRS, and QCL type D with the same TRS when applicable.

In some implementations, the UE shall expect that a TCI state indicates QCL type A with TRS, and QCL type D with TRS when applicable.

In some implementations, TRS or CSI-RS in a QCL-Info of the TCI state can be applied for DM-RS of PDSCH and PDCCH. Note that scheme-3 can be applied for the case that TRS or CSI-RS is configured or not configured for candidate cell or candidate target cell or target cell or serving cell.
Scheme-4: UE shall expect that a TCI state indicates QCL type A with SSB associated with TRS, and QCL type D with the SSB associated with TRS when applicable.

In some implementations, the UE shall expect that a TCI state indicates QCL type A with SSB, and QCL type D with SSB when applicable. Preferably, SSB is associated with TRS.

In some implementations, the UE shall expect that a TCI state indicates QCL type A with SSB associated with TRS, and QCL type D with the same SSB associated with TRS when applicable.

In some implementations, the UE shall expect that a TCI state indicates QCL type A with SSB, and QCL type D with the same SSB when applicable. Preferably, SSB is associated with TRS.
Scheme-5: UE shall expect that a TCI state indicates QCL type C with SSB, and QCL type D with SSB when applicable. Optionally, SSB is associated with TRS.

In some implementations, the UE shall expect that a TCI state indicates QCL type C with SSB associated with TRS, and QCL type D with SSB associated with TRS when applicable.

In some implementations, the UE shall expect that a TCI state indicates QCL type C with SSB, and QCL type D with the same SSB when applicable. Optionally, SSB is associated with TRS.

In some implementations, the UE shall expect that a TCI state indicates QCL type C with SSB associated with TRS, and QCL type D with the same SSB associated with TRS when applicable.

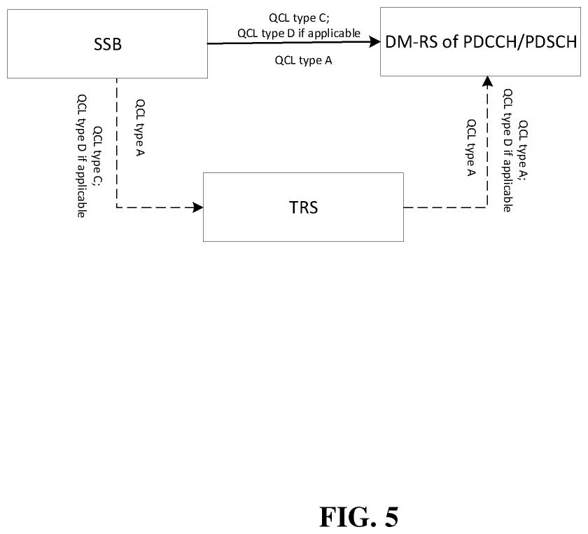

For scheme-4 and/or scheme-5, FIG. 5 provides QCL relationship, such as QCL type A/C and D with SSB associated with TRS for DMRS of PDCCH/PDSCH. FIG. 5 illustrates a QCL type A/C and D with SSB associated with TRS for DMRS of PDCCH/PDSCH.

In some implementations, SSB associated with CSI-RS or TRS can be applied as QCL reference RS for DM-RS of PDSCH and PDCCH. One of the following implementations can be considered:
Alt-1: SSB with regard to QCL-TypeC and SSB with regard to QCL-TypeD, if applicable.
Alt-2: SSB with regard to QCL-TypeA and SSB with regard to QCL-TypeD, if applicable.
Scheme-6: UE shall expect that a TCI state indicates QCL type A with TRS, and QCL type D with the same TRS when applicable. In some implementations, TRS is associated with SSB.

In some implementations, the UE shall expect that a TCI state indicates QCL type A with TRS, and QCL type D with TRS when applicable. In some implementations, TRS is associated with SSB.

In some implementations, the UE shall expect that a TCI state indicates QCL type A with TRS associated with SSB, and QCL type D with TRS associated with SSB when applicable.

In some implementations, the UE shall expect that a TCI state indicates QCL type A with TRS associated with SSB, and QCL type D with the same TRS associated with SSB when applicable.

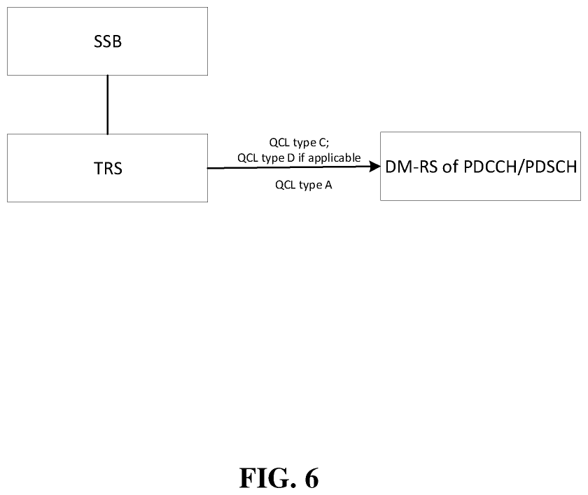

For scheme-6, FIG. 6 provides QCL relationship, such as QCL type A/C and D with TRS associated with SSB for DMRS of PDCCH/PDSCH. FIG. 6 illustrates QCL type A/C and D with TRS associated with SSB for DMRS of PDCCH/PDSCH.
Scheme-7: UE shall expect that DM-RS of PDSCH or PDCCH is quasi co-located with the SSB or CSI-RS. Optionally, SSB or CSI-RS is configured or associated with candidate cell or candidate target cell or target cell or serving cell. Optionally, at least one of SSB or CSI-RS is QCL source or reference RS in TCI state. Optionally, SSB is associated with CSI-RS indicated in TCI state, or CSI-RS is associated with SSB indicated in TCI state, or CSI-RS indicated in TCI state is associated with SSB indicated in TCI state. Note that these two TCI states can be same or different TCI states.

In legacy specification, TRS is required as a reference RS for QCL-TypeA in a TCI state for the DM-RS of PDSCH and PDCCH. However, according to the previous RAN1 agreement, it has been agreed that TRS and/or RS can be configured as QCL source RS in TCI state. Based on this, the following cases need to be defined for the DM-RS of PDSCH and PDCCH (w.r.t is the abbreviation for “with regard to”):
Case-1: SSB w.r.t QCL-TypeC+TRS w.r.t QCL-TypeA, if applicable
Case-2: SSB w.r.t QCL-TypeC+SSB w.r.t QCL-TypeD, if applicable
Case-3: SSB w.r.t QCL-TypeA+SSB w.r.t QCL-TypeD, if applicable
Case-4: SSB w.r.t QCL-TypeA+TRS w.r.t QCL-TypeA, if applicable
Case-5: SSB w.r.t QCL-TypeA+TRS w.r.t QCL-TypeD, if applicable
Case-6: TRS w.r.t QCL-TypeA and TRS w.r.t QCL-TypeD, if applicable
Case-7: TRS w.r.t QCL-TypeA and SSB w.r.t QCL-TypeD, if applicable
Case-8: TRS w.r.t QCL-TypeA and SSB w.r.t QCL-TypeC, if applicable

### Potential Specification

For the DM-RS of PDCCH and/or PDCCH, if the UE is configured with LTM-dl-OrJointTCI-StateList, the UE shall expect that an indicated TCI-State in cell switch command indicates one of the following quasi co-location type(s):
‘typeC’ with a SS/PBCH block and when applicable, ‘typeA’ with a CSI-RS resource in a LTM-NZP-CSI-RS-ResourceSet configured with higher layer parameter trs-Info, or
‘typeC’ with a SS/PBCH block and when applicable, ‘typeD’ with the SS/PBCH block, or
‘typeA’ with a SS/PBCH block and when applicable, ‘typeD’ with the SS/PBCH block, or
‘typeA’ with a SS/PBCH block and when applicable, ‘typeA’ with a CSI-RS resource in a LTM-NZP-CSI-RS-ResourceSet configured with higher layer parameter trs-Info, or
‘typeA’ with a SS/PBCH block and when applicable, ‘typeD’ with a CSI-RS resource in a LTM-NZP-CSI-RS-ResourceSet configured with higher layer parameter trs-Info, or
‘typeA’ with a CSI-RS resource in a LTM-NZP-CSI-RS-ResourceSet configured with higher layer parameter trs-Info and, when applicable, ‘typeD’ with the same CSI-RS resource, or
‘typeA’ with a CSI-RS resource in a LTM-NZP-CSI-RS-ResourceSet configured with higher layer parameter trs-Info and, when applicable, ‘typeD’ with a SS/PBCH block, or
‘typeA’ with a CSI-RS resource in a LTM-NZP-CSI-RS-ResourceSet configured with higher layer parameter trs-Info and, when applicable, ‘typeC’ with a SS/PBCH block.

In some implementations, CSI-RS resource set or CSI-RS resource may have a PCI different from the PCI of the serving cell, or cell information for CSI-RS resource or CSI-RS resource set can be determined by relationship at least of CSI-RS source, CSI-RS resource set, SSB and Cell index or PCI. In some implementations, SS/PBCH block may have a PCI different from the PCI of the serving cell or a PCI of candidate cell.

In some implementations, any QCL-Type mentioned in the above cases can be replaced with ‘typeA’, or ‘typeB’ or ‘typeC’, or ‘typeD’.

### Example Embodiment 4

Regarding TCI state(s) activated before cell switch command, at least one of the following can be considered:
Option-1: only maintain TCI states for subsequent candidate cells to switch.
Option-2: maintain all of activated TCI states before cell switch command, CSC. Optionally, if one candidate cell is no longer a cell in the candidate cell list, discard corresponding TCI states.
Option-3: maintain all activated TCI states for candidate cell(s) and/or target cell. Optionally, except indicated TCI state in cell switch command.
Option-4: only maintain TCI state(s) for target candidate cell or target cell.
Option-5: deactivated TCI state(s) for candidate cell(s) and/or target cell. Optionally, the deactivation of the TCI state(s) can proceed except indicated TCI state in cell switch command.
Option-6: not keeping any activated TCI state before CSC and apply indicated TCI state by CSC until new TCI state is activated and/or indicated.
Option-7: TCI state(s) or activated TCI state(s) is updated by a signaling after cell switch command.
Option-8: whether to maintain and/or deactivate one or multiple or all activated TCI state(s) for candidate cell(s) and/or target cell can be determined based on configuration or is configurable or depends on UE capability.

Regarding relationship between TCI state list provided in RRC pre-configuration and TCI state list included in serving cell configuration corresponding to target cell index indicated in cell switch command, the former (TCI state list provided in RRC pre-configuration) is a subset of the latter (TCI state list included in serving cell configuration).

As for whether UE needs to retain activated TCI state before cell switch command, network can deactivate all activated TCI states for candidate cell (even including target cell) after switching to target cell. The activation of all activated TCI states can be achieved by MAC CE TCI state activation or deactivation signaling.

Regarding the reasons for deactivating all activated TCI states, in some implementations, the activated TCI states before cell switch command can only provide wide beam information, while after cell switch command, fine beam information is required and can be obtained from TCI state configured for target cell. In addition, the previously maintained TCI state may no longer be suitable for the current target cell after a period of time.

In some implementations, a field to indicate 1 joint or 1 pair of UL and DL unified TCI State index for the target cell field is always present in the cell switch command. UE can use the indicated TCI state to receive or transmit DL or UL information from/to target cell until new TCI state is indicated or obtained by target cell. Optionally, the method to obtain new beam or TCI state can be based on CFRA (Contention Free Random Access) procedure or CBRA (Contention-based Random Access) procedure indicated and/or triggered in and/or after cell switch command.

In some implementations, if CFRA resource related information is indicated in cell switch command, RS index indicated in TCI state indicated in cell switch command can be associated with RO resource indicated in cell switch command. Optionally, the above mentioned RS index can be provided in cell switch command. Optionally, at least one of preamble index, RO resource, or mask information can be indicated in cell switch command.

### Example Embodiment 5

This embodiment relates to providing a method on CSI-RS configuration for a cell. In some implementations, a cell includes at least one of a serving cell and a candidate cell. By providing the method on CSI-RS configuration for the cell, it is possible to reduce overhead of RRC configuration.

In some implementations, CSI-RS configuration can include at least of CSI-RS configuration for beam management, CSI-RS configuration for tracking, CSI-RS configuration for mobility, CSI-RS configuration for interference measurement, CSI-RS configuration for channel measurement, or CSI-RS configuration for CSI acquisition.

At least one of the following configurations can be considered:
Full or complete CSI-RS configuration
Cell-specific CSI-RS configuration
Common CSI-RS configuration

In some implementations, full or complete CSI-RS configuration can be configured for one or more cells in a cell list, e.g., at least a portion of the cells in the cell list or all cells in the cell list.

In some implementations, the cell-specific CSI-RS configuration can be configured for a cell. Optionally, it can be used to provide necessary or particular information for the cell. In some implementations, the cell-specific CSI-RS configuration can be independently or separately configured for a different cell.

In some implementations, the common CSI-RS configuration can be configured for multiple cells or all of cells in the cell list. Optionally, it is used to provide some basic or shared information.

In some implementations, the full or complete CSI-RS configuration can be obtained by at least one of the following:
Option-1: The full or complete CSI-RS configuration information can be obtained by RRC signaling, such as the full or complete CSI-RS configuration.
Option-2: The full or complete CSI-RS configuration information can be obtained by at least one of the cell-specific CSI-RS configuration or common CSI-RS configuration, e.g., the combination of the cell cell-specific CSI-RS configuration or the common CSI-RS configuration.

In some examples, assuming that for CSI-RS configuration for tracking, it can be obtained by the complete CSI-RS for tracking configuration, or the combination of the cell-specific CSI-RS for tracking configuration and the common CSI-RS for tracking configuration, or the combination of i) CSI-RS resource ID or CSI-RS resource set ID for tracking and ii) the cell-specific CSI-RS for tracking configuration corresponding to or associated with the same CSI-RS resource ID or CSI-RS resource set ID for tracking. In some implementations, the same logic or method can be applied for CSI-RS configuration for other uses cases.

Full or complete CSI-RS configuration, or Cell-specific CSI-RS configuration, or Common CSI-RS configuration includes at least one of offset between signaling and CSI-RS transmission, the number of CSI-RS resource or CSI-RS resource set, time gap between CSI-RS resources or CSI-RS resource set, indication to trigger CSI-RS transmission, CSI-RS resource ID, Frequency domain allocation within a physical resource block, the number of ports, Time domain allocation within a physical resource block, CDM type, Density of CSI-RS resource measured in RE/port/PRB, starting of CSI-RS in frequency domain, Number of PRBs across which CSI-RS resource spans in frequency domain, the offset of power control, scramblingID, periodicity, offset within periodicity, RS index, TCI state ID, CSI-RS resource set ID, CSI-RS resource ID(s) associated with CSI-RS resource set ID, cell index, offset between DCI that triggers aperiodic CSI-RS resource and CSI-RS transmission, offset to indicate CSI-RS transmission resource, an indication of CSI-RS for tracking, BWP index, RACH configuration, SRS information, subcarrier spacing, Frequency, point A, Reference cell ID and so on.

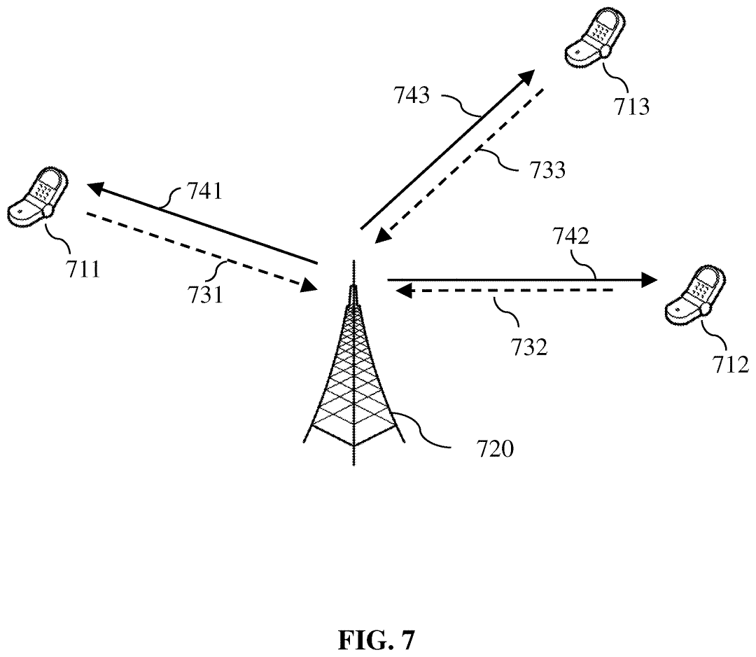

FIG. 7 shows an example of a wireless communication system (e.g., a long term evolution (LTE), 5G or NR cellular network) that includes a BS 720 and one or more user equipment (UE) 711, 712 and 713. In some embodiments, the uplink transmissions (731, 732, 733) can include uplink control information (UCI), higher layer signaling (e.g., UE assistance information or UE capability), or uplink information. In some embodiments, the downlink transmissions (741, 742, 743) can include DCI or high layer signaling or downlink information. The UE may be, for example, a smartphone, a tablet, a mobile computer, a machine to machine (M2M) device, a terminal, a mobile device, an Internet of Things (IoT) device, and so on.

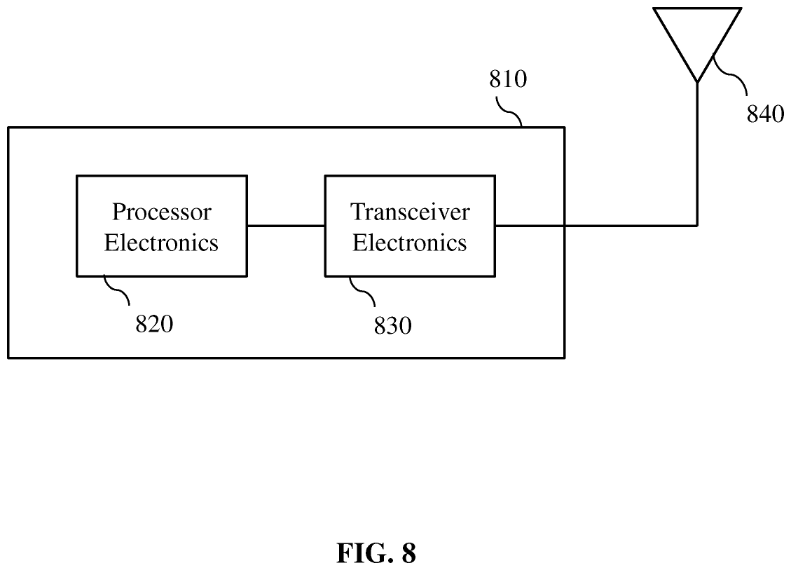

FIG. 8 is a block diagram representation of a portion of an apparatus, in accordance with some embodiments of the presently disclosed technology. An apparatus 810 such as a network device or a base station or a wireless device (or UE), can include processor electronics 820 such as a microprocessor that implements one or more of the techniques presented in this document. The apparatus 810 can include transceiver electronics 830 to send and/or receive wireless signals over one or more communication interfaces such as antenna(s) 840. The apparatus 810 can include other communication interfaces for transmitting and receiving data. Apparatus 810 can include one or more memories (not explicitly shown) configured to store information such as data and/or instructions. In some implementations, the processor electronics 820 can include at least a portion of the transceiver electronics 830. In some embodiments, at least some of the disclosed techniques, modules or functions are implemented using the apparatus 810.

A listing of examples preferred by some embodiments is provided next.

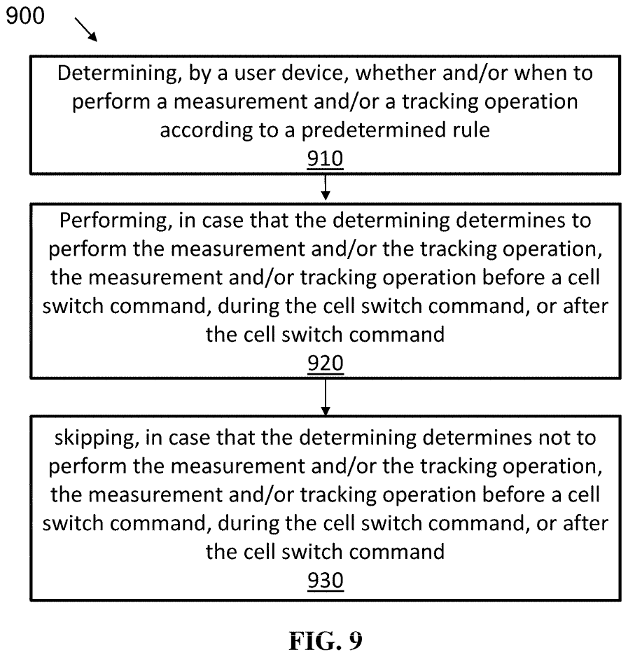

The first set of clauses show example embodiments of techniques discussed in the previous section.
1. A method (e.g., method 900 in FIG. 9) for wireless communication, comprising: determining 910, by a user device, whether and/or when to perform a measurement and/or a tracking operation according to a predetermined rule; performing 920, in case that the determining determines to perform the measurement and/or the tracking operation, the measurement and/or tracking operation before a cell switch command, during the cell switch command, or after the cell switch command; and skipping 930, in case that the determining determines not to perform the measurement and/or the tracking operation, the measurement and/or tracking operation before a cell switch command, during the cell switch command, or after the cell switch command.
2. The method of solution 1, wherein the performing the measurement and/or the tracking operation before the cell switch command includes at least one of.
1) performing the measurement and/or the tracking operation through reference signal (RS); 2) performing the measurement and/or the tracking operation through RS index indicated in a TCJ state; 3) performing the measurement and/or the tracking operation through RS index associated with RS index indicated in a TCJ state; 4) performing the measurement and/or the tracking operation through RS index indicated in an activated or selected TCJ state; 5) performing the measurement and/or the tracking operation through RS index associated with RS index indicated in an activated or selected TCJ state; 6) performing the measurement and/or the tracking operation through RS index indicated in an activated or selected TCJ state before the cell switch command; 7) performing the measurement and/or the tracking operation through RS index associated with RS index indicated in an activated or selected TCJ state before the cell switch command; 8) performing the measurement and/or the tracking operation through RS that is allowed and/or configured and/or enabled; 9) performing the measurement and/or tracking operation through RS that is allowed and/or configured and/or enabled before the cell switch command; 10) performing the measurement and/or the tracking operation through RS, where RS based measurement and/or tracking and/or RS related configuration is allowed and/or configured and/or enabled; 11) performing the measurement and/or the tracking operation through RS, where RS based measurement and/or tracking and/or RS related configuration is allowed and/or configured and/or enabled before the cell switch command; 12) performing the measurement and/or the tracking operation through RS associated with RS and/or PRACH occasion (RO) and/or Preamble; 13) performing the measurement and/or the tracking operation through RS associated with RS and/or RO and/or Preamble provided by PDCCH order signaling or TA acquisition operation; or 14) performing the measurement and/or the tracking operation through RS indicated in PDCCH order signaling or TA acquisition operation.
3. The method of solution 1, wherein the performing the measurement and/or the tracking operation during the cell switch command includes at least one of:
1) performing the measurement and/or the tracking operation through reference signal (RS); 2) performing the measurement and/or the tracking operation through RS index indicated in a TCI state; 3) performing the measurement and/or the tracking operation through RS index associated with RS index indicated in a TCI state; 4) performing the measurement and/or the tracking operation through RS index indicated in a TCI state; where the TCI state is activated or selected before cell switch command; 5) performing the measurement and/or the tracking operation through RS index associated with RS index indicated in a TCI state, where the TCI state is activated or selected before cell switch command; 6) performing the measurement and/or the tracking operation through RS index indicated in a TCI state indicated and/or activated or selected in the cell switch command; 7) performing the measurement and/or the tracking operation through RS index associated with RS index indicated in a TCI state indicated and/or activated or selected in the cell switch command; 8) performing the measurement and/or the tracking operation through RS index indicated in the cell switch command; 9) performing the measurement and/or the tracking operation through RS index associated with RS index indicated in the cell switch command; 10) performing the measurement and/or the tracking operation through an indication to trigger and/or indicate the measurement and/or tracking indicated in the cell switch command; 11) performing the measurement and/or the tracking operation through RS that is allowed or configured or enabled before or during the cell switch command; 12) performing the measurement and/or the tracking operation through RS, where RS based measurement and/or tracking and/or RS related configuration is allowed and/or configured and/or enabled; 13) performing the measurement and/or the tracking operation through RS, where RS based measurement and/or tracking and/or RS related configuration is allowed and/or configured and/or enabled before or during the cell switch command; 14) performing the measurement and/or the tracking operation through RS associated with RS and/or RO and/or Preamble; 15) performing the measurement and/or the tracking operation through RS associated with RS and/or RO and/or Preamble provided by PDCCH order signaling or TA acquisition operation; 16) performing the measurement and/or the tracking operation through RS associated with RS and/or RO and/or Preamble provided by TA acquisition operation or PDCCH order signaling or an indication to trigger TA acquisition indicated in cell switch command; 17) performing the measurement and/or the tracking operation through RS associated with RS and/or RO and/or Preamble provided by PDCCH order signaling or TA acquisition operation, where PDCCH order based RACH or TA acquisition operation is done or PDCCH order signaling is received before the cell switch command; 18) performing the measurement and/or the tracking operation through RS provided by PDCCH order signaling or TA acquisition operation before the cell switch command; or 19) performing the measurement and/or the tracking operation through RS, where RS position information and/or offset between signaling to trigger measurement and/or the tracking operation and RS transmission indicated in cell switch command.
4. The method of solution 1, wherein the performing the measurement and/or the tracking operation after the cell switch command includes at least one of:
1) performing the measurement and/or the tracking operation through reference signal (RS); 2) performing the measurement and/or the tracking operation through RS index indicated in a TCI state; 3) performing the measurement and/or the tracking operation through RS index associated with RS index indicated in a TCI state; 4) performing the measurement and/or the tracking operation through RS index indicated in a TCI state indicated in the cell switch command; 5) performing the measurement and/or the tracking operation through RS index associated with RS index indicated in a TCI state indicated in the cell switch command; 6) performing the measurement and/or the tracking operation through RS index indicated in a TCI state, where the TCI state is one of TCI states activated before or by cell switch command; 7) performing the measurement and/or the tracking operation through RS index associated with RS index indicated in a TCI state, where the TCI state is one of TCI states activated before or by cell switch command; 8) performing the measurement and/or the tracking operation through an indication to trigger and/or indicate the measurement and/or tracking operation indicated in the cell switch command; 9) performing the measurement and/or the tracking operation through RS, where RS position information and/or offset between signaling to trigger measurement and/or the tracking operation and RS transmission indicated in cell switch command; 10) performing the measurement and/or the tracking operation through an indication to trigger and/or indicate the measurement and/or the tracking operation provided after the cell switch command; 11) performing the measurement and/or the tracking operation through RS, where RS position information and/or offset between signaling to trigger measurement and/or the tracking operation and RS transmission provided after the cell switch command; 12) performing the measurement and/or the tracking operation through RS that is allowed or configured or enabled before or during or after the cell switch command; 13) performing the measurement and/or the tracking operation through RS, where RS based measurement and/or tracking, and/or RS related configuration is allowed and/or configured and/or enabled; 14) performing the measurement and/or the tracking operation through RS, where RS based measurement and/or tracking, and/or RS related configuration is allowed and/or configured and/or enabled before or during or after the cell switch command; 15) performing the measurement and/or the tracking operation through RS associated with RS and/or RO and/or Preamble; 16) performing the measurement and/or the tracking operation through RS associated with RS and/or RO and/or Preamble provided by PDCCH order signaling or TA acquisition operation; 17) performing the measurement and/or the tracking operation through RS associated with RS and/or RO and/or Preamble provided by TA acquisition operation or PDCCH order signaling or an indication to trigger TA acquisition indicated in cell switch command; 18) performing the measurement and/or the tracking operation through RS associated with RS and/or RO and/or Preamble provided by PDCCH order signaling or TA acquisition operation, where PDCCH order based RACH or TA acquisition operation is done or PDCCH order signaling is received before the cell switch command or PDCCH order based RACH or TA acquisition operation is triggered during cell switch command; or 19) performing the measurement and/or the tracking operation through RS provided by PDCCH order signaling or TA acquisition operation before or during the cell switch command.
5. The method of solution 1, wherein the predetermined rule includes at least one of:
1) RRC configuration or information; 2) MAC CE signaling indication or information; 3) RS related configuration or information; 4) measurement and/or the tracking based on RS; 5) allowing and/or enabling and/or configuration of RS related configuration or information; 6) Configuration or enabling or allowing of measurement and/or the tracking based on RS; 7) the RS for the measurement and/or the tracking operation indicated in TCI state; 8) the RS for the measurement and/or the tracking operation indicated in TCI state activated before cell switch command; 9) the RS for the measurement and/or the tracking operation indicated in TCI state activated and/or indicated in cell switch command; 10) whether the RS for the measurement and/or the tracking operation configured as QCL source RS indicated in TCI state; 11) whether the RS for the measurement and/or the tracking operation configured as QCL source RS indicated in TCI state activated before cell switch command; 12) whether the RS for the measurement and/or the tracking operation configured as QCL source RS indicated in TCI state activated and/or indicated in cell switch command; 13) an indication to trigger or indicate the CSI-RS or the TRS or the CSI-RS for tracking; 14) enabling or triggering of TA acquisition or PDCCH order based RACH or UE based TA measurement; 15) receiving of PDCCH order signaling; 16) the measurement and/or the tracking operation through RS before the cell switch command, or during the cell switch command, after the cell switch command is configurable or depends on a capability of the user device; 17) the RS for the measurement and/or the tracking operation configured as QCL source RS indicated in an activated TCI state or an indicated TCI state in the cell switch command or TCI state is configurable or depends on the capability of the user device; 18) whether RS related configuration is provided or configured or obtained by the user device before the cell switch command, or during the cell switch command, after the cell switch command; 19) relationship between RS index for measurement and/or the tracking operation and RS related configuration and/or TCI state index and/or RS and/or Preamble and/or RO; 20) whether RS for measurement and/or the tracking operation is associated with or corresponding to RS indicated in TCI state; 21) RS for measurement and/or the tracking operation is associated with or corresponding to RS indicated in TCI state.
6. The method of solution 1, wherein the determining determines to perform the measurement and/or the tracking operation before the cell switch command in case at least one of following is met: i) CSI-RS or TRS or CSI-RS for tracking or SSB is indicated in a TCI state; ii) CSI-RS or TRS or CSI-RS for tracking or SSB is indicated in a TCI state if at least one of CSI-RS measurement or TRS or CSI-RS for tracking is allowed and/or configured and/or enabled; iii) at least one of CSI-RS measurement or TRS or CSI-RS for tracking is allowed and/or configured and/or enabled; iv) TA acquisition or PDCCH order based RACH or UE based TA measurement is enabled or allowed or PDCCH order signaling is received or indicated; v) CSI-RS or TRS or CSI-RS for tracking or SSB is configured or allowed as QCL source RS indicated in TCI state; vi) CSI-RS related configuration is configured or obtained; or vii) relationship between CSI-RS or TRS or CSI-RS for tracking or SSB for measurement and/or tracking and CSI-RS related configuration and/or TCI state index and/or RS and/or Preamble and/or RO is provided.
7. The method of solution 1, wherein the determining determines not to perform the measurement and/or the tracking operation in case at least one of following is met: i) CSI-RS related configuration is not or is configured or obtained; ii) at least one of CSI-RS measurement or TRS or CSI-RS for tracking is not or is allowed and/or configured and/or enabled; iii) CSI-RS or TRS or CSI-RS for tracking or SSB is not or is configured or allowed as QCL source RS indicated in TCI state; iv) specific information on CSI-RS measurement or TRS or CSI-RS for tracking is not configured or provided; v) CSI-RS or TRS or CSI-RS for tracking is or is not indicated in a TCI state without specific information in CSI-RS related configuration; vi) CSI-RS or TRS or CSI-RS for tracking is or is not indicated in TCI state; vii) TA acquisition or PDCCH order based RACH or UE based TA measurement is ot is not enabled or allowed or PDCCH order signaling is or is not received or indicated; viii) relationship between CSI-RS or TRS or CSI-RS for tracking or SSB for measurement and/or tracking and CSI-RS related configuration and/or TCI state index and/or RS and/or Preamble and/or RO is or is not provided; ix) an indication to trigger and/or indicate the measurement and/or the tracking operation is or is not provided or indicated; or x) RS position information and/or offset between signaling to trigger measurement and/or the tracking operation and RS transmission is or is not provided or indicated.
8. The method of solution 1, wherein the determining determines to perform the measurement and/or the tracking operation during or when receiving the cell switch command in case at least one of the following is met: i) CSI-RS or TRS or CSI-RS for tracking is indicated in TCI state indicated and/or activated/selected in cell switch command; ii) CSI-RS or TRS or CSI-RS for tracking is indicated by an indication to trigger or indicate the CSI-RS or the TRS or the CSI-RS for tracking indicated in the cell switch command; iii) CSI-RS or TRS or CSI-RS for tracking is not allowed or not completed before the cell switch command, or allowed and/or configured and/or enabled during cell switch command; iv) CSI-RS or TRS or CSI-RS for tracking associated with SSB or CSI-RS is indicated in TCI state indicated and/or activated/selected in cell switch command; v) CSI-RS or TRS or CSI-RS for tracking associated with SSB or CSI-RS is indicated in TCI state indicated and/or activated/selected in cell switch command, where SSB or CSI-RS is measured and/or tracked before cell switch command; vi) CSI-RS or TRS or CSI-RS for tracking associated with SSB or CSI-RS is indicated in TCI state indicated and/or activated/selected in cell switch command, where SSB or CSI-RS is indicated in TCI state activated before the cell switch command; vii) CSI-RS or TRS or CSI-RS for tracking associated with SSB or CSI-RS is indicated in TCI state indicated and/or activated/selected in cell switch command, where SSB or CSI-RS is indicated in TCI state; viii) SSB is indicated in TCI state indicated and/or activated by cell switch command; ix) SSB is indicated in TCI state activated and/or indicated in the cell switch command, where SSB is associated with CSI-RS or TRS or SSB or CSI-RS for tracking; x) CSI-RS or TRS or CSI-RS for tracking or SSB is configured or allowed as QCL source RS indicated in TCI state; xi) RS position information and/or offset between signaling to trigger measurement and/or the tracking operation and RS transmission is provided or indicated by cell switch command; xii) CSI-RS related configuration is configured or obtained before or by or during cell switch command; xiii) at least one of CSI-RS measurement or TRS or CSI-RS for tracking or SSB for tracking is allowed and/or configured and/or enabled; xiv) TA acquisition or PDCCH order based RACH or UE based TA measurement is enabled or allowed or PDCCH order signaling is received or indicated; or xv) relationship between CSI-RS or TRS or CSI-RS for tracking or SSB for measurement and/or tracking and CSI-RS related configuration and/or TCI state index and/or RS and/or Preamble and/or RO is provided.
9. The method of solution 1, wherein the determining determines to perform the measurement and/or the tracking operation after the cell switch command in case at least one of the following is met: i) CSI-RS or TRS or CSI-RS for tracking is indicated in TCI state indicated and/or activated/selected in cell switch command; ii) CSI-RS or TRS or CSI-RS for tracking is triggered by a signaling and/or indicated in CSI-RS related information; iii) CSI-RS or TRS or CSI-RS for tracking is indicated in TCI state indicated and/or activated/selected in the cell switch command, where CSI-RS or TRS or CSI-RS for tracking is SSB measured and/or indicated in TCI state activated before the cell switch command; iv) the CSI-RS or TRS or CSI-RS for tracking is associated with SSB indicated in a TCI state activated before the cell switch command, and/or, indicated in the cell switch command; v) the SSB is indicated in TCI state activated before the cell switch command, and/or, indicated and/or activated/selected in the cell switch command, where SSB is associated with or corresponding to SSB for tracking or CSI-RS for tracking or TRS or CSI-RS; vi) the SSB is indicated in TCI state activated before cell switch command, and/or, indicated and/or activated/selected in the cell switch command; vii) CSI-RS or TRS or CSI-RS for tracking or SSB for tracking is not allowed or not completed before cell switch command or during cell switch command; viii) CSI-RS or TRS or CSI-RS for tracking or SSB for tracking is allowed and/or configured and/or enabled; ix) CSI-RS related configuration is configured or obtained; x) CSI-RS related configuration is configured or obtained before or by or during or after cell switch command; xi) TA acquisition or PDCCH order based RACH or UE based TA measurement is enabled or allowed or triggered or PDCCH order signaling is received or indicated; or xii) relationship between CSI-RS or TRS or CSI-RS for tracking or SSB for measurement and/or tracking and CSI-RS related configuration and/or TCI state index and/or RS and/or Preamble and/or RO is provided.

The second set of clauses show example embodiments of techniques discussed in the previous section.
1. A method (e.g., method 900 in FIG. 9) for wireless communication, comprising: determining 910, by a user device, whether and/or when to perform a measurement and/or a tracking operation according to a predetermined rule; performing 920, in case that the determining determines to perform the measurement and/or the tracking operation, the measurement and/or tracking operation before a cell switch command, during the cell switch command, or after the cell switch command; and skipping 930, in case that the determining determines not to perform the measurement and/or the tracking operation, the measurement and/or tracking operation before a cell switch command, during the cell switch command, or after the cell switch command.
2. The method of solution 1, further comprising: receiving, by the user device from a network device, a signaling that activates or selects one or more multiple transmission configuration indication (TCI) states.
3. The method of solution 1, wherein the performing the measurement and/or the tracking operation before the cell switch command, during the cell switch command, or after the cell switch command includes at least one of: performing the measurement and/or the tracking operation through reference signal (RS), wherein the RS is i) allowed and/or configured and/or enabled, or ii) indicated or associated with RS and/or PRACH occasion (RO) and/or Preamble a) in a RACH procedure, or b) indicated in PDCCH order signaling or TA acquisition operation; or performing the measurement and/or the tracking operation through iii) an indication to trigger and/or indicate the measurement and/or the tracking operation, or iv) position information of the RS and/or an offset between a signaling to trigger the measurement and/or the tracking operation and a transmission of the RS.
4. The method of solution 1, wherein the performing the measurement and/or the tracking operation before the cell switch command, during the cell switch command, or after the cell switch command includes at least one of: performing the measurement and/or the tracking operation through RS, wherein the RS is indicated or associated with RS indicated in a i) TCI state, ii) TCI state activated and/or indicated in the cell switch command, or iii) TCI state activated or selected by a signaling.
5. The method of solution 1, wherein the predetermined rule is obtained from at least one of the following: RRC configuration or information; MAC CE signaling indication or information; RS related configuration or information; allowing and/or enabling and/or configuration of RS related configuration or information; configuration or enabling or allowing of measurement and/or the tracking based on RS; receiving of PDCCH order signaling; an indication to trigger or indicate the CSI-RS or the TRS or the CSI-RS for tracking, enabling or triggering of TA acquisition or PDCCH order based RACH or UE based TA measurement; or a relationship between RS index for measurement and/or the tracking operation and RS related configuration and/or TCI state index and/or RS and/or Preamble and/or RO.
6. The method of solution 1, wherein the predetermined rule includes at least one of: whether the RS for the measurement and/or the tracking operation configured as QCL source RS indicated in TCI state; whether the RS for the measurement and/or the tracking operation configured as QCL source RS indicated in TCI state activated before cell switch command; whether the RS for the measurement and/or the tracking operation configured as QCL source RS indicated in TCI state activated and/or indicated in cell switch command; whether RS related configuration is provided or configured or obtained by the user device before the cell switch command, or during the cell switch command, after the cell switch command; or whether RS for measurement and/or the tracking operation is indicated or associated with or corresponding to RS indicated in TCI state.
7. The method of any of solutions 3 to 6, wherein at least one of the following is satisfied: the RS or the RS index is associated with or corresponds to or related to i) RS related configuration, ii) TCI state or TCI state index, iii) RS and/or RO and/or preamble for TA acquisition, or iv) a cell index; or a TCI state containing the RS or the RS index is associated with or corresponds to or related to i) RS related configuration, ii) RS and/or RO and/or preamble for TA acquisition, or iii) the cell index; or the RS related configuration is associated with or corresponds to or related to the cell index.
8. The method of any of solutions 3 to 7, wherein the RS is Synchronization Signal/PBCH Block (SSB) or channel state information reference signal (CSI-RS) or CSI-RS for tracking or Tracking reference signal (TRS) or SRS.
9. The method of solution 8, wherein, for the RS being the CSI-RS or the CSI-RS for tracking or the TRS or SRS, RS related information or configuration is configured according to at least one of the following: the RS related information or configuration with or without specific information on the RS is configured and/or obtained and/or enabled before the cell switch command; the RS related information or configuration with the specific information on the RS is configured and/or obtained and/or enabled by the cell switch command or after the cell switch command; or the RS related information or configuration with the specific information on the RS is acquired by a configuration corresponding to a cell index or a target cell index indicated or obtained in the cell switch command.
10. The method of solution 8, wherein, for the RS being the CSI-RS or CSI-RS for tracking or the TRS or SRS, including at least one of: the RS related information or configuration is configured for at least a portion of cells in a cell list; the RS related information or configuration is configured for each cell; the RS related information or configuration is configured for multiple cells in the cell list; the RS related information or configuration is complete or full RS related configuration; the RS related information or configuration is common RS related configuration for one or multiple cells; the RS related information or configuration is a part of RS related configuration; the RS related information or configuration does not carry or contain or configure specific information on the RS.
11. The method of any of solutions 8 to 10, wherein i) a CSI-RS index or TRS index or CSI-RS index for tracking indicated in a TCI state, or ii) CSI-RS index or TRS index or CSI-RS index for tracking, or iii) TCI state containing CSI-RS index or TRS index or CSI-RS index for tracking is associated with or corresponding to at least one of: one or multiple CSI-RS resource indices, CSI-RS resource set indices, or CSI-RS resources within a CSI-RS resource set in the CSI-RS related configuration, offset between signaling and CSI-RS transmission, TCI state index, or cell index.
12. The method of any of solution 1, wherein the determining determines to perform the measurement and/or the tracking operation before the cell switch command in case at least one of following is met: i) CSI-RS or TRS or CSI-RS for tracking or SSB is indicated in a TCI state; ii) CSI-RS or TRS or CSI-RS for tracking or SSB is indicated in a TCI state if at least one of CSI-RS measurement or TRS or CSI-RS for tracking is allowed and/or configured and/or enabled; iii) at least one of CSI-RS measurement or TRS or CSI-RS for tracking is allowed and/or configured and/or enabled; iv) TA acquisition or PDCCH order based RACH or UE based TA measurement is enabled or allowed or PDCCH order signaling is received or indicated; v) CSI-RS or TRS or CSI-RS for tracking or SSB is configured or allowed as QCL source RS indicated in TCI state; vi) CSI-RS related configuration is configured or obtained; or vii) relationship between CSI-RS or TRS or CSI-RS for tracking or SSB for measurement and/or tracking and CSI-RS related configuration and/or TCI state index and/or RS and/or Preamble and/or RO is provided.
13. The method of solution 1, wherein the determining determines not to perform the measurement and/or the tracking operation in case at least one of following is met: i) CSI-RS related configuration is configured or obtained; ii) at least one of CSI-RS measurement or TRS or CSI-RS for tracking is allowed and/or configured and/or enabled; iii) CSI-RS or TRS or CSI-RS for tracking or SSB is configured or allowed as QCL source RS indicated in TCI state; or iv) specific information on CSI-RS measurement or TRS or CSI-RS for tracking is not configured or provided.
14. The method of solution 1 or 13, wherein the determining determines not to perform the measurement and/or the tracking operation in case at least one of following is met: i) CSI-RS related configuration is not configured or obtained; ii) at least one of CSI-RS measurement or TRS or CSI-RS for tracking is not allowed and/or configured and/or enabled; or iii) CSI-RS or TRS or CSI-RS for tracking or SSB is not configured or allowed as QCL source RS indicated in TCI state.
15. The method of solution 1 or 12, wherein the determining determines to perform the measurement and/or the tracking operation during or when receiving the cell switch command or after the cell switch command in case at least one of the following is met: i) CSI-RS or TRS or CSI-RS for tracking or SSB is indicated in TCI state indicated and/or activated/selected in cell switch command; ii) CSI-RS or TRS or CSI-RS for tracking is indicated and/or triggered by an indication to trigger or indicate the CSI-RS or the TRS or the CSI-RS for tracking indicated in the cell switch command; iii) CSI-RS or TRS or CSI-RS for tracking is not allowed or not completed before the cell switch command, or allowed and/or configured and/or enabled during the cell switch command; iv) CSI-RS related configuration is configured or obtained and/or enabled before or by or during cell switch command;
16. The method of solution 1 or 12 or 15, wherein the determining determines to perform the measurement and/or the tracking operation during or when receiving the cell switch command or after the cell switch command in case at least one of the following is met: i) SSB is indicated in TCI state indicated and/or activated by cell switch command; ii) SSB is indicated in TCI state activated and/or indicated in the cell switch command, where SSB is associated with CSI-RS or TRS or SSB or CSI-RS for tracking; iii) CSI-RS or TRS or CSI-RS for tracking or SSB is configured or allowed as QCL source RS indicated in TCI state; ix) RS position information and/or offset between signaling to trigger measurement and/or the tracking operation and RS transmission is provided or indicated by cell switch command; ix) at least one of CSI-RS measurement or TRS or CSI-RS for tracking or SSB for tracking is allowed and/or configured and/or enabled; xi) TA acquisition or PDCCH order based RACH or UE based TA measurement is enabled or allowed or PDCCH order signaling is received or indicated; or xii) relationship between CSI-RS or TRS or CSI-RS for tracking or SSB for measurement and/or tracking and CSI-RS related configuration and/or TCI state index and/or RS and/or Preamble and/or RO is provided.
17. The method of solution 1, wherein a TCI state is applied for DM-RS of physical downlink shared channel (PDSCH) or physical downlink control channel (PDCCH), wherein the TCI state indicates i) QCL type A and/or QCL type D with TRS or CSI-RS or CSI-RS for tracking, ii) QCL type A and/or, QCL type C and/or QCL type D with SSB, or iii) QCL type A, and/or QCL type C, and/or QCL type D with SSB associated with TRS or CSI-RS or CSI-RS for tracking.
18. The method of solution 8, wherein the SSB or the TRS or the CSI-RS or the CSI-RS for tracking is configured as the QCL source in a TCI state i) indicated and/or activated in a cell switch command or ii) activated by a signaling before cell switch command.
19. The method of solution 8, wherein the CSI-RS or the CSI-RS for tracking or the TRS related configuration includes at least one of the following: CSI-RS resource configuration, or CSI-RS resource set configuration, offset between signaling and CSI-RS transmission, the number of CSI-RS resource or CSI-RS resource set, time gap between CSI-RS resources or CSI-RS resource set, indication to trigger CSI-RS transmission, CSI-RS resource ID, Frequency domain allocation within a physical resource block, the number of ports, Time domain allocation within a physical resource block, CDM type, Density of CSI-RS resource measured in RE/port/PRB, starting of CSI-RS in frequency domain, Number of PRBs across which CSI-RS resource spans in frequency domain, the offset of power control, scramblingID, periodicity, offset within periodicity, RS index, TCI state ID, CSI-RS resource set ID, CSI-RS resource ID(s) associated with CSI-RS resource set ID, cell index, offset between DCI that triggers aperiodic CSI-RS resource and CSI-RS transmission, offset to indicate CSI-RS transmission resource, an indication of CSI-RS for tracking, BWP index, RACH configuration, SRS information, subcarrier spacing, Frequency, point A, Reference cell ID.
20. The method of solution 2, 4, or 17, wherein the signaling is a RRC signaling, a MAC CE signaling, or a DCI signaling.
21. The method of solution 1, further comprising: maintaining a TCI state based on a predetermined rule that sets a condition to maintain the TCI state based on timing of an activation and/or indication of the TCI state in relation to a cell switch command.
22. A wireless communication apparatus comprising a processor configured to implement a method recited in any of above solutions.
23. A computer storage medium having code stored thereupon, the code, upon execution by a processor, causing the processor to implement a method recited in any of above solutions.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method for wireless communication, comprising:
determining, by a user device, whether and/or when to perform a measurement and/or a tracking operation according to a predetermined rule;
performing, in case that the determining determines to perform the measurement and/or the tracking operation, the measurement and/or tracking operation before a cell switch command, during the cell switch command, or after the cell switch command; and
skipping, in case that the determining determines not to perform the measurement and/or the tracking operation, the measurement and/or tracking operation before a cell switch command, during the cell switch command, or after the cell switch command.

2. The method of claim 1, further comprising:
receiving, from a network device, a signaling that activates or selects one or more multiple transmission configuration indication (TCI) states, wherein the signaling is a RRC signaling, a MAC CE signaling, or a DCI signaling; or
maintaining, by the user device, a TCI state based on a predetermined rule that sets a condition to maintain the TCI state based on timing of an activation and/or indication of the TCI state in relation to a cell switch command.

3. The method of claim 1, wherein the performing the measurement and/or the tracking operation before the cell switch command, during the cell switch command, or after the cell switch command includes at least one of:
performing the measurement and/or the tracking operation through reference signal (RS), wherein the RS is i) allowed and/or configured and/or enabled, or ii) indicated or associated with RS and/or PRACH occasion (RO) and/or Preamble a) in a RACH procedure, or b) indicated in physical downlink control channel (PDCCH) order signaling or TA acquisition operation;
performing the measurement and/or the tracking operation through iii) an indication to trigger and/or indicate the measurement and/or the tracking operation, or iv) position information of the RS and/or an offset between a signaling to trigger the measurement and/or the tracking operation and a transmission of the RS; or
performing the measurement and/or the tracking operation through RS, wherein the RS is indicated or associated with RS indicated in a i) TCI state, ii) TCI state activated and/or indicated in the cell switch command, or iii) TCI state activated or selected by a signaling.

4. The method of claim 1, wherein the predetermined rule is obtained from at least one of following:
RRC configuration or information;
MAC CE signaling indication or information;
RS related configuration or information;
allowing and/or enabling and/or configuration of RS related configuration or information;
configuration or enabling or allowing of measurement and/or the tracking based on RS;
receiving of PDCCH order signaling;
an indication to trigger or indicate channel state information reference signal (CSI-RS) or tracking reference signal (TRS) or the CSI-RS for tracking;
enabling or triggering of timing advance (TA) acquisition or PDCCH order based random access channel (RACH) or UE based TA measurement;
a relationship between RS index for measurement and/or the tracking operation and RS related configuration and/or TCI state index and/or RS and/or Preamble and/or RO;
whether the RS for the measurement and/or the tracking operation configured as QCL source RS indicated in TCI state;
whether the RS for the measurement and/or the tracking operation configured as QCL source RS indicated in TCI state activated before cell switch command;
whether the RS for the measurement and/or the tracking operation configured as QCL source RS indicated in TCI state activated and/or indicated in cell switch command;
whether RS related configuration is provided or configured or obtained by the user device before the cell switch command, or during the cell switch command, after the cell switch command; or
whether RS for measurement and/or the tracking operation is indicated or associated with or corresponding to RS indicated in TCI state.

5. The method of claim 3, wherein at least one of following is satisfied:
the RS or a RS index is associated with or corresponds to or related to i) RS related configuration, ii) TCI state or TCI state index, iii) RS and/or RO and/or preamble for TA acquisition, or iv) a cell index; or
a TCI state containing the RS or the RS index is associated with or corresponds to or related to i) RS related configuration, ii) RS and/or RO and/or preamble for TA acquisition, or iii) the cell index; or
the RS related configuration is associated with or corresponds to or related to the cell index.

6. The method of claim 3, wherein the RS is Synchronization Signal/PBCH Block (SSB) or channel state information reference signal (CSI-RS) or CSI-RS for tracking or Tracking reference signal (TRS) or SRS, wherein i) a CSI-RS index or TRS index or CSI-RS index for tracking indicated in a TCI state, or ii) CSI-RS index or TRS index or CSI-RS index for tracking, or iii) TCI state containing CSI-RS index or TRS index or CSI-RS index for tracking is associated with or corresponding to at least one of: one or multiple CSI-RS resource indices, CSI-RS resource set indices, or CSI-RS resources within a CSI-RS resource set in CSI-RS related configuration, offset between signaling and CSI-RS transmission, TCI state index, or cell index.

7. The method of claim 6, wherein, for the RS being the CSI-RS or the CSI-RS for tracking or the TRS or SRS, RS related information or configuration is configured according to at least one of following:
the RS related information or configuration with or without specific information on the RS is configured and/or obtained and/or enabled before the cell switch command;
the RS related information or configuration with the specific information on the RS is configured and/or obtained and/or enabled by the cell switch command or after the cell switch command;
the RS related information or configuration with the specific information on the RS is acquired by a configuration corresponding to a cell index or a target cell index indicated or obtained in the cell switch command
the RS related information or configuration is configured for at least a portion of cells in a cell list;
the RS related information or configuration is configured for each cell;
the RS related information or configuration is configured for multiple cells in the cell list;
the RS related information or configuration is complete or full RS related configuration;
the RS related information or configuration is common RS related configuration for one or multiple cells;
the RS related information or configuration is a part of RS related configuration;
the RS related information or configuration does not carry or contain or configure specific information on the RS.

8. The method of claim 1, wherein the determining determines to perform the measurement and/or the tracking operation before the cell switch command in case at least one of following is met:
i) CSI-RS or TRS or CSI-RS for tracking or SSB is indicated in a TCI state;
ii) CSI-RS or TRS or CSI-RS for tracking or SSB is indicated in a TCI state if at least one of CSI-RS measurement or TRS or CSI-RS for tracking is allowed and/or configured and/or enabled;
iii) at least one of CSI-RS measurement or TRS or CSI-RS for tracking is allowed and/or configured and/or enabled;
iv) TA acquisition or PDCCH order based RACH or UE based TA measurement is enabled or allowed or PDCCH order signaling is received or indicated;
v) CSI-RS or TRS or CSI-RS for tracking or SSB is configured or allowed as QCL source RS indicated in TCI state;
vi) CSI-RS related configuration is configured or obtained; or
vii) relationship between CSI-RS or TRS or CSI-RS for tracking or SSB for measurement and/or tracking and CSI-RS related configuration and/or TCI state index and/or RS and/or Preamble and/or RO is provided.

9. The method of claim 1, wherein the determining determines not to perform the measurement and/or the tracking operation in case at least one of following is met:
i) CSI-RS related configuration is configured or obtained;
ii) at least one of CSI-RS measurement or TRS or CSI-RS for tracking is allowed and/or configured and/or enabled;
iii) CSI-RS or TRS or CSI-RS for tracking or SSB is configured or allowed as QCL source RS indicated in TCI state;
iv) specific information on CSI-RS measurement or TRS or CSI-RS for tracking is not configured or provided;
v) CSI-RS related configuration is not configured or obtained;
vi) at least one of CSI-RS measurement or TRS or CSI-RS for tracking is not allowed and/or configured and/or enabled; or
vii) CSI-RS or TRS or CSI-RS for tracking or SSB is not configured or allowed as QCL source RS indicated in TCI state.

10. The method of claim 1, wherein the determining determines to perform the measurement and/or the tracking operation during or when receiving the cell switch command or after the cell switch command in case at least one of following is met:
i) CSI-RS or TRS or CSI-RS for tracking or SSB is indicated in TCI state indicated and/or activated/selected in cell switch command;
ii) CSI-RS or TRS or CSI-RS for tracking is indicated and/or triggered by an indication to trigger or indicate the CSI-RS or the TRS or the CSI-RS for tracking indicated in the cell switch command;
iii) CSI-RS or TRS or CSI-RS for tracking is not allowed or not completed before the cell switch command, or allowed and/or configured and/or enabled during the cell switch command;
iv) CSI-RS related configuration is configured or obtained and/or enabled before or by or during cell switch command;
v) SSB is indicated in TCI state indicated and/or activated by cell switch command;
vi) SSB is indicated in TCI state activated and/or indicated in the cell switch command, where SSB is associated with CSI-RS or TRS or SSB or CSI-RS for tracking;
vii) CSI-RS or TRS or CSI-RS for tracking or SSB is configured or allowed as QCL source RS indicated in TCI state;
viii) RS position information and/or offset between signaling to trigger measurement and/or the tracking operation and RS transmission is provided or indicated by cell switch command;
ix) at least one of CSI-RS measurement or TRS or CSI-RS for tracking or SSB for tracking is allowed and/or configured and/or enabled;
x) TA acquisition or PDCCH order based RACH or UE based TA measurement is enabled or allowed or PDCCH order signaling is received or indicated; or
xi) relationship between CSI-RS or TRS or CSI-RS for tracking or SSB for measurement and/or tracking and CSI-RS related configuration and/or TCI state index and/or RS and/or Preamble and/or RO is provided.

11. The method of claim 1, wherein a TCI state is applied for DM-RS of physical downlink shared channel (PDSCH) or physical downlink control channel (PDCCH), wherein the TCI state indicates i) QCL type A and/or QCL type D with TRS or CSI-RS or CSI-RS for tracking, ii) QCL type A and/or, QCL type C and/or QCL type D with SSB, or iii) QCL type A, and/or QCL type C, and/or QCL type D with SSB associated with TRS or CSI-RS or CSI-RS for tracking.

12. The method of claim 6,
wherein the SSB or the TRS or the CSI-RS or the CSI-RS for tracking is configured as a QCL source in a TCI state i) indicated and/or activated in a cell switch command or ii) activated by a signaling before cell switch command, or
wherein the CSI-RS or the CSI-RS for tracking or the TRS related configuration includes at least one of following: CSI-RS resource configuration, or CSI-RS resource set configuration, offset between signaling and CSI-RS transmission, the number of CSI-RS resource or CSI-RS resource set, time gap between CSI-RS resources or CSI-RS resource set, indication to trigger CSI-RS transmission, CSI-RS resource ID, Frequency domain allocation within a physical resource block, the number of ports, Time domain allocation within a physical resource block, CDM type, Density of CSI-RS resource measured in RE/port/PRB, starting of CSI-RS in frequency domain, Number of PRBs across which CSI-RS resource spans in frequency domain, the offset of power control, scramblingID, periodicity, offset within periodicity, RS index, TCI state ID, CSI-RS resource set ID, CSI-RS resource ID(s) associated with CSI-RS resource set ID, cell index, offset between DCI that triggers aperiodic CSI-RS resource and CSI-RS transmission, offset to indicate CSI-RS transmission resource, an indication of CSI-RS for tracking, BWP index, RACH configuration, SRS information, subcarrier spacing, Frequency, point A, Reference cell ID.

13. A wireless communication apparatus comprising at least one processor configured to cause the wireless communication apparatus to implement a method comprising:
determining whether and/or when to perform a measurement and/or a tracking operation according to a predetermined rule;
performing, in case that the determining determines to perform the measurement and/or the tracking operation, the measurement and/or tracking operation before a cell switch command, during the cell switch command, or after the cell switch command; and
skipping, in case that the determining determines not to perform the measurement and/or the tracking operation, the measurement and/or tracking operation before a cell switch command, during the cell switch command, or after the cell switch command.

14. The wireless communication apparatus of claim 13, wherein the method further comprises:
receiving, from a network device, a signaling that activates or selects one or more multiple transmission configuration indication (TCI) states, wherein the signaling is a RRC signaling, a MAC CE signaling, or a DCI signaling, or
maintaining a TCJ state based on a predetermined rule that sets a condition to maintain the TCJ state based on timing of an activation and/or indication of the TCJ state in relation to a cell switch command.

15. The wireless communication apparatus of claim 13, wherein the performing the measurement and/or the tracking operation before the cell switch command, during the cell switch command, or after the cell switch command includes at least one of:
performing the measurement and/or the tracking operation through reference signal (RS), wherein the RS is i) allowed and/or configured and/or enabled, or ii) indicated or associated with RS and/or PRACH occasion (RO) and/or Preamble a) in a RACH procedure, or b) indicated in PDCCH order signaling or TA acquisition operation;
performing the measurement and/or the tracking operation through iii) an indication to trigger and/or indicate the measurement and/or the tracking operation, or iv) position information of the RS and/or an offset between a signaling to trigger the measurement and/or the tracking operation and a transmission of the RS; or
performing the measurement and/or the tracking operation through RS, wherein the RS is indicated or associated with RS indicated in a i) TCJ state, ii) TCJ state activated and/or indicated in the cell switch command, or iii) TCJ state activated or selected by a signaling.

16. The wireless communication apparatus of claim 13, wherein the predetermined rule is obtained from at least one of following:
RRC configuration or information;
MAC CE signaling indication or information;
RS related configuration or information;
allowing and/or enabling and/or configuration of RS related configuration or information;
configuration or enabling or allowing of measurement and/or the tracking based on RS;
receiving of PDCCH order signaling;
an indication to trigger or indicate CSI-RS or TRS or CSI-RS for tracking;
enabling or triggering of TA acquisition or PDCCH order based RACH or UE based TA measurement;
a relationship between RS index for measurement and/or the tracking operation and RS related configuration and/or TCI state index and/or RS and/or Preamble and/or RO;
whether the RS for the measurement and/or the tracking operation configured as QCL source RS indicated in TCI state;
whether the RS for the measurement and/or the tracking operation configured as QCL source RS indicated in TCI state activated before cell switch command;
whether the RS for the measurement and/or the tracking operation configured as QCL source RS indicated in TCI state activated and/or indicated in cell switch command;
whether RS related configuration is provided or configured or obtained by the wireless communication apparatus before the cell switch command, or during the cell switch command, after the cell switch command; or
whether RS for measurement and/or the tracking operation is indicated or associated with or corresponding to RS indicated in TCI state.

17. The wireless communication apparatus of claim 13, wherein the determining determines to perform the measurement and/or the tracking operation before the cell switch command in case at least one of following is met:
i) CSI-RS or TRS or CSI-RS for tracking or SSB is indicated in a TCI state;
ii) CSI-RS or TRS or CSI-RS for tracking or SSB is indicated in a TCI state if at least one of CSI-RS measurement or TRS or CSI-RS for tracking is allowed and/or configured and/or enabled;
iii) at least one of CSI-RS measurement or TRS or CSI-RS for tracking is allowed and/or configured and/or enabled;
iv) TA acquisition or PDCCH order based RACH or UE based TA measurement is enabled or allowed or PDCCH order signaling is received or indicated;
v) CSI-RS or TRS or CSI-RS for tracking or SSB is configured or allowed as QCL source RS indicated in TCI state;
vi) CSI-RS related configuration is configured or obtained; or
vii) relationship between CSI-RS or TRS or CSI-RS for tracking or SSB for measurement and/or tracking and CSI-RS related configuration and/or TCI state index and/or RS and/or Preamble and/or RO is provided.

18. The wireless communication apparatus of claim 13, wherein the determining determines not to perform the measurement and/or the tracking operation in case at least one of following is met:
i) CSI-RS related configuration is configured or obtained;
ii) at least one of CSI-RS measurement or TRS or CSI-RS for tracking is allowed and/or configured and/or enabled;
iii) CSI-RS or TRS or CSI-RS for tracking or SSB is configured or allowed as QCL source RS indicated in TCI state;
iv) specific information on CSI-RS measurement or TRS or CSI-RS for tracking is not configured or provided;
v) CSI-RS related configuration is not configured or obtained;
vi) at least one of CSI-RS measurement or TRS or CSI-RS for tracking is not allowed and/or configured and/or enabled; or
vii) CSI-RS or TRS or CSI-RS for tracking or SSB is not configured or allowed as QCL source RS indicated in TCI state.

19. The wireless communication apparatus of claim 13, wherein the determining determines to perform the measurement and/or the tracking operation during or when receiving the cell switch command or after the cell switch command in case at least one of following is met:
i) CSI-RS or TRS or CSI-RS for tracking or SSB is indicated in TCI state indicated and/or activated/selected in cell switch command;
ii) CSI-RS or TRS or CSI-RS for tracking is indicated and/or triggered by an indication to trigger or indicate the CSI-RS or the TRS or the CSI-RS for tracking indicated in the cell switch command;
iii) CSI-RS or TRS or CSI-RS for tracking is not allowed or not completed before the cell switch command, or allowed and/or configured and/or enabled during the cell switch command;
iv) CSI-RS related configuration is configured or obtained and/or enabled before or by or during cell switch command;
v) SSB is indicated in TCI state indicated and/or activated by cell switch command;
vi) SSB is indicated in TCI state activated and/or indicated in the cell switch command, where SSB is associated with CSI-RS or TRS or SSB or CSI-RS for tracking;
vii) CSI-RS or TRS or CSI-RS for tracking or SSB is configured or allowed as QCL source RS indicated in TCI state;
viii) RS position information and/or offset between signaling to trigger measurement and/or the tracking operation and RS transmission is provided or indicated by cell switch command;
ix) at least one of CSI-RS measurement or TRS or CSI-RS for tracking or SSB for tracking is allowed and/or configured and/or enabled;
x) TA acquisition or PDCCH order based RACH or UE based TA measurement is enabled or allowed or PDCCH order signaling is received or indicated; or
xi) relationship between CSI-RS or TRS or CSI-RS for tracking or SSB for measurement and/or tracking and CSI-RS related configuration and/or TCI state index and/or RS and/or Preamble and/or RO is provided.

20. The wireless communication apparatus of claim 13, wherein a TCI state is applied for DM-RS of physical downlink shared channel (PDSCH) or physical downlink control channel (PDCCH), wherein the TCI state indicates i) QCL type A and/or QCL type D with TRS or CSI-RS or CSI-RS for tracking, ii) QCL type A and/or, QCL type C and/or QCL type D with SSB, or iii) QCL type A, and/or QCL type C, and/or QCL type D with SSB associated with TRS or CSI-RS or CSI-RS for tracking.
